(19) United States
(12) Patent Application Publication
(10) Pub. No.: US 2025/0126645 A1
(43) Pub. Date: Apr. 17, 2025

(54) ENABLING COORDINATED MULTIPLE ACCESS ON MULTIPLE PRIMARY CHANNELS

(71) Applicant: QUALCOMM Incorporated, San Diego, CA (US)

(72) Inventors: Gaurang NAIK, San Diego, CA (US); Abhishek Pramod PATIL, San Diego, CA (US); Yanjun SUN, San Diego, CA (US); Abdel Karim AJAMI, San Diego, CA (US); George CHERIAN, San Diego, CA (US); Alfred ASTERJADHI, San Diego, CA (US); Sai Yiu Duncan HO, San Diego, CA (US)

(21) Appl. No.: 18/485,126

(22) Filed: Oct. 11, 2023

(51) Int. Cl. H04W 74/08; H04W 16/28

(52) U.S. Cl. CPC H04W 74/0816; H04W 16/28

(57) ABSTRACT

This disclosure provides methods, components, devices and systems for enabling coordinated multiple access on multiple primary channels. Some aspects more specifically relate to inter access point (AP) coordination to share a portion of a transmission opportunity (TXOP). A first AP may transmit a first signal on a secondary primary channel conveying an indication that a portion of the TXOP is available for sharing. The second AP may respond with a confirmation on the secondary primary channel that the second AP is tuned to the secondary primary channel. Accordingly, the second AP may transmit a second signal on the secondary primary channel to the first AP indicating that the portion of the TXOP is available for use. The second AP may use the portion of the TXOP to communicate with one or more station(s) on the secondary primary channel.

### TECHNICAL FIELD

This disclosure relates to wireless communication and, more specifically, to enabling coordinated multiple access on multiple primary channels.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a wireless device (such as an AP or a STA) may contend for access to a wireless medium using a primary wireless channel. If the wireless medium is occupied, the wireless device may switch to another primary wireless channel and refrain from using the occupied channel for a period of time.

### SUMMARY

The systems, methods, and devices of this disclosure each have several innovative aspects, no single one of which is solely responsible for the desirable attributes disclosed herein.

One innovative aspect of the subject matter described in this disclosure may be implemented in a first access point (AP). For example, a method for wireless communications by a first AP is described. The method may include transmitting, to a second AP, a first signal on a secondary primary channel indicating that the first AP has a portion of a TXOP available to share with the second AP; and transmitting a second signal on the secondary primary channel to the second AP indicating that the portion of the TXOP is available for use by the second AP.

A first AP for wireless communications is described. The first AP may include a processing system that includes processor circuitry and memory circuitry that stores code. The processing system may be configured to cause the first AP to transmit, to a second AP, a first signal on a secondary primary channel indicating that the first AP has a portion of a TXOP available to share with the second AP; and transmit a second signal on the secondary primary channel to the second AP indicating that the portion of the TXOP is available for use by the second AP.

Another first AP for wireless communications is described. The first AP may include means for transmitting, to a second AP, a first signal on a secondary primary channel indicating that the first AP has a portion of a TXOP available to share with the second AP; and means for transmitting a second signal on the secondary primary channel to the second AP indicating that the portion of the TXOP is available for use by the second AP.

A non-transitory computer-readable medium storing code for wireless communications is described. The code may include instructions executable by a processor to transmit, to a second AP, a first signal on a secondary primary channel indicating that the first AP has a portion of a TXOP available to share with the second AP; and transmit a second signal on the secondary primary channel to the second AP indicating that the portion of the TXOP is available for use by the second AP.

Some examples of the method, first APs, and non-transitory computer-readable medium described herein may further include operations, features, means, or instructions for exchanging capability signaling with the second AP indicating support for multiple access techniques on multiple primary channels, where the secondary primary channel includes at least one of the multiple primary channels and the transmitting the first signal, the second signal, or both, on the secondary primary channel may be based on the capability signaling.

In some examples of the method, first APs, and non-transitory computer-readable medium described herein, the capability signaling indicates support for at least one of: sharing the portion of the TXOP and receiving a shared portion of the TXOP, receiving a shared portion of the TXOP, or sharing the portion of the TXOP.

Some examples of the method, first APs, and non-transitory computer-readable medium described herein may further include operations, features, means, or instructions for supporting for all secondary primary channels in the multiple primary channels, supporting for sharing a subset of secondary primary channels in the multiple primary channels, or both.

In some examples of the method, first APs, and non-transitory computer-readable medium described herein, transmitting the first signal may include operations, features, means, or instructions for transmitting, to the second AP, a transmission allocation message on the secondary primary channel identifying resources allocated to the portion of the TXOP and confirming that the second AP may be tuned to the secondary primary channel according to a response message received from the second AP.

In some examples of the method, first APs, and non-transitory computer-readable medium described herein, transmitting the first signal may include operations, features, means, or instructions for transmitting, to the second AP, an initial control frame (ICF) message on the secondary primary channel to confirm that the second AP may be tuned to the secondary primary channel, confirming that the second AP may be tuned to the secondary primary channel according to a response received from the second AP, and transmitting, to the second AP, a transmission allocation message on the secondary primary channel identifying resources allocated to the portion of the TXOP.

Some examples of the method, first APs, and non-transitory computer-readable medium described herein may further include operations, features, means, or instructions for re-tuning from the secondary primary channel to a primary channel upon transmission of the second signal, the second AP associated with multiple primary channels that include the primary channel and the secondary primary channel.

Some examples of the method, first APs, and non-transitory computer-readable medium described herein may further include operations, features, means, or instructions for monitoring a primary channel to determine that the primary channel may be unavailable for access during the TXOP having a duration associated with an overlapping TXOP on the primary channel, the first AP associated with multiple primary channels that include the primary channel and the secondary primary channel and monitoring the secondary primary channel to determine that the secondary primary channel may be available for access, where the first signal may be transmitted based on the access.

Another innovative aspect of the subject matter described in this disclosure may be implemented in a second AP. For example, a method for wireless communications by a second AP is described. The method may include receiving, from a first AP, a first signal indicating that the first AP has a portion of a TXOP available to share with the second AP and receiving, from the first AP, a second signal on a secondary primary channel indicating that the portion of the TXOP is available for use by the second AP.

A second AP for wireless communications is described. The second AP may include a processing system that includes processor circuitry and memory circuitry that stores code. The processing system may be configured to cause the second AP to receive, from a first AP, a first signal indicating that the first AP has a portion of a TXOP available to share with the second AP and receive, from the first AP, a second signal on a secondary primary channel indicating that the portion of the TXOP is available for use by the second AP.

Another second AP for wireless communications is described. The second AP may include means for receiving, from a first AP, a first signal indicating that the first AP has a portion of a TXOP available to share with the second AP and means for receiving, from the first AP, a second signal on a secondary primary channel indicating that the portion of the TXOP is available for use by the second AP.

A non-transitory computer-readable medium storing code for wireless communications is described. The code may include instructions executable by a processor to receive, from a first AP, a first signal indicating that the first AP has a portion of a TXOP available to share with the second AP and receive, from the first AP, a second signal on a secondary primary channel indicating that the portion of the TXOP is available for use by the second AP.

Some examples of the method, second APs, and non-transitory computer-readable medium described herein may further include operations, features, means, or instructions for exchanging capability signaling with the first AP indicating support for multiple access techniques on multiple primary channels, where the secondary primary channel includes at least one of the multiple primary channels and the receiving the first signal, the second signal, or both, may be based on the capability signaling.

In some examples of the method, first APs, and non-transitory computer-readable medium described herein, the capability signaling may indicate support for at least one of: sharing the portion of the TXOP and receiving a shared portion of the TXOP, receiving a shared portion of the TXOP, or sharing the portion of the TXOP.

In some examples of the method, second APs, and non-transitory computer-readable medium described herein, the capability signaling may indicate at least one of: support for all secondary primary channels in the multiple primary channels, support for sharing a subset of secondary primary channels in the multiple primary channels, or both.

In some examples of the method, second APs, and non-transitory computer-readable medium described herein, receiving the first signal may include operations, features, means, or instructions for receiving, from the first AP, a transmission allocation message on the secondary primary channel identifying resources allocated to the portion of the TXOP and transmitting a response to the first AP according to the transmission allocation message, where the response confirms that the second AP may be tuned to the secondary primary channel.

In some examples of the method, second APs, and non-transitory computer-readable medium described herein, receiving the first signal may include operations, features, means, or instructions for receiving, from the first AP, an ICF message on the secondary primary channel, transmitting a response to the first AP according to the ICF message, where the response confirms that the second AP may be tuned to the secondary primary channel, and receiving, from the first AP, a transmission allocation message on the secondary primary channel identifying resources allocated to the portion of the TXOP.

Some examples of the method, second APs, and non-transitory computer-readable medium described herein may further include operations, features, means, or instructions for re-tuning from the secondary primary channel to a primary channel upon expiration of communicating with one or more wireless stations during the portion of the TXOP, the second AP associated with multiple primary channels that include the primary channel and the secondary primary channel.

Some examples of the method, second APs, and non-transitory computer-readable medium described herein may further include operations, features, means, or instructions for identifying, based on the first signal, a secondary subband that may be associated with the secondary primary channel available for sharing during the portion of the TXOP, where communicating with one or more wireless stations during the portion of the TXOP may be performed in the secondary subband.

Some examples of the method, second APs, and non-transitory computer-readable medium described herein may further include operations, features, means, or instructions for communicating, based on a start time of the TXOP, with one or more wireless stations during a second portion of the TXOP and in a primary subband, where the primary subband may be a different subband than the secondary subband and the second portion of the TXOP occurs earlier in a time domain than the portion of the TXOP.

Some examples of the method, second APs, and non-transitory computer-readable medium described herein may further include operations, features, means, or instructions for monitoring a primary channel in a primary subband and the secondary primary channel in the secondary subband and communicating, based on a result of the monitoring, with one or more wireless stations during a second portion of the TXOP and in the primary subband, where the first subband may be a different subband than the second subband and the second portion of the TXOP occurs earlier in a time domain than the portion of the TXOP.

Some examples of the method, second APs, and non-transitory computer-readable medium described herein may further include operations, features, means, or instructions for transmitting an indication that the second AP may be refraining from communicating with one or more wireless stations during the portion of the TXOP.

Some examples of the method, second APs, and non-transitory computer-readable medium described herein may further include operations, features, means, or instructions for monitoring a primary channel to determine that the primary channel may be unavailable for access, the second AP associated with multiple primary channels that include the primary channel and the secondary primary channel and identifying, based on the first signal and a result of the monitoring, a secondary subband associated with the secondary primary channel available for sharing during the portion of the TXOP, where communicating with one or more wireless stations during the portion of the TXOP may be performed in the secondary subband.

Some examples of the method, second APs, and non-transitory computer-readable medium described herein may further include operations, features, means, or instructions for monitoring a primary channel to determine that the primary channel may be unavailable for access, the second AP associated with multiple primary channels that include the primary channel and the secondary primary channel and identifying, based on the first signal and a result of the monitoring, a primary subband and a secondary subband available for sharing during the portion of the TXOP, where communicating with one or more wireless stations during the portion of the TXOP may be performed in the primary subband and the secondary subband.

Some examples of the method, second APs, and non-transitory computer-readable medium described herein may further include operations, features, means, or instructions for reducing a transmit power level for the communicating with the one or more wireless stations in the primary subband according to a spatial reuse scheme, the spatial reuse scheme based on the primary channel being unavailable for access.

Some examples of the method, second APs, and non-transitory computer-readable medium described herein may further include operations, features, means, or instructions for transmitting a control message to the first AP releasing the portion of the TXOP to the first AP.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a hierarchical format of an example physical layer protocol data unit (PPDU) usable for communications between a wireless access point (AP) and one or more wireless stations (STAs).

FIG. 3 shows an example of a resource diagram that supports enabling coordinated multiple access on multiple primary channels.

FIG. 4 shows an example of a resource diagram that supports enabling coordinated multiple access on multiple primary channels.

FIG. 5 shows an example of a resource diagram that supports enabling coordinated multiple access on multiple primary channels.

FIG. 6 shows an example of a resource diagram that supports enabling coordinated multiple access on multiple primary channels.

FIG. 7 shows an example of a resource diagram that supports enabling coordinated multiple access on multiple primary channels.

FIG. 8 shows an example of a resource diagram that supports enabling coordinated multiple access on multiple primary channels.

FIG. 9 shows a block diagram of an example wireless communication device that supports enabling coordinated multiple access on multiple primary channels.

FIG. 10 shows a flowchart illustrating an example process performable by or at a first AP that supports enabling coordinated multiple access on multiple primary channels.

FIG. 11 shows a flowchart illustrating an example process performable by or at a second AP that supports enabling coordinated multiple access on multiple primary channels.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. Some or all of the described implementations may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described implementations can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described implementations also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to multi-primary channel access in systems that include a primary channel (sometimes referred to as a main primary channel) and multiple secondary primary channels (sometimes referred to as other primary channels), and wherein the various aspects relate more particularly to secondary primary channel coordination techniques to support sharing aspects of the secondary primary channel between access points (APs). In some wireless networks that support multi-primary channel access, APs can use multiple primary channels to access the wireless medium to communicate with other wireless devices. If a first AP performs a channel contention procedure and determines that a primary channel is occupied by a second wireless device, the first AP may switch to a secondary primary channel and monitor for channel access. In some implementations, after gaining access to the primary channel, the second wireless device may advertise a network allocation vector (NAV) to let other wireless devices (such as the first AP) know how long the second wireless device intends to use the primary channel. The duration of time for which the second wireless device can use the primary channel, known as a transmit opportunity (TXOP), may help the first AP determine when the first primary channel will become available again.

Similarly, the first AP may obtain access to the wireless medium through a secondary primary channel. The first AP may coordinate with a second AP to share some of the TXOP. For example, the first AP may transmit a first signal on the secondary primary channel carrying or otherwise conveying an indication that a portion of the TXOP is available for sharing. The second AP may optionally respond with a confirmation on the secondary primary channel that the second AP is tuned to the secondary primary channel and will share the portion of the TXOP with the first AP. Accordingly, the second AP may transmit a second signal on the secondary primary channel to the first AP indicating that the portion of the TXOP is available for use. The second AP may use the portion of the TXOP to communicate with one or more wireless stations (STAs) in the secondary primary channel.

In some implementations, the primary channel and the secondary primary channel may be sub-channels within an operating bandwidth (such as in multi-primary channel access, which also may be referred to as coordinated-TDMA (C-TDMA)). In some other implementations, the primary channel and the secondary primary channel may be different links (such as in enhanced multi-link single radio (eMLSR) AP systems). Although some aspects of the present disclosure are described in the context of multi-primary channel access, the concepts and techniques described herein also apply to eMLSR AP systems.

The first signal from the first AP may include timing information, bandwidth-related information, STA service information, synchronization information, TXOP sharing information, or a combination thereof. For example, the first AP may transmit an indication of whether a NAV advertised by the second wireless device accurately reflects the duration of an upcoming TXOP on the second channel, an indication of a bandwidth the second wireless device intends to use during an upcoming restricted target wake time (R-TWT) service period, a list of STAs the second wireless device intends to serve on the second channel, an indication that the first AP has lost synchronization on the first channel, or an indication that the second wireless device successfully gained access to the second channel, among other implementations.

Particular aspects of the subject matter described in this disclosure can be implemented to realize one or more of the following potential advantages. In some implementations, by coordinating and sharing the secondary primary channel, the described techniques can be used to improve resource utilization and reduce latency. For example, when a bandwidth-limited overlapping basic service set (OBSS) captures the wireless medium using the primary channel, sharing the unused portion of the frequency resources during the TXOP may avoid waste. Additionally, or alternatively, sharing the unused available resources during the shared portion of the OBSS TXOP reduces the amount of time that the second AP waits for communicating with STA(s) within its coverage area.

For C-TDMA, the signal from the second wireless device may improve the performance of the first AP by enabling the first AP to utilize the secondary primary channel and attain higher throughput, reduced latency, and to achieve other advantages. Without the signal, the first AP may be unable to access the secondary primary channel, as the first AP may operate according to incorrect or unreliable NAV information.

For TXOP sharing, providing or otherwise transferring a TXOP to the second AP may reduce the delay associated with gaining access to the secondary primary channel, thereby enabling the second AP to transmit and receive packets with reduced latency.

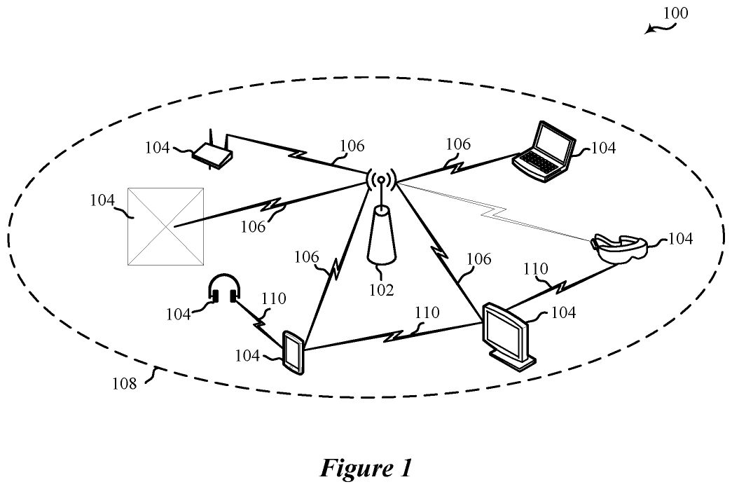

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other implementations, the wireless communication network 100 can be an example of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any quantity or set of STAs 104. While one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other implementations. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other implementations.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such implementations, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Implementations of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low latency requirements, or may provide lossless audio to one or more other devices. For example, the AP 102 or the STAs 104 may support applications and use implementations associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

In some implementations, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled with a different power amplifier). In some other implementations, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other implementations in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other implementations, signals for transmission may be generated by four or more different transmit chains of the wireless communication device, each having a bandwidth of 80 MHz.

In noncontiguous implementations, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

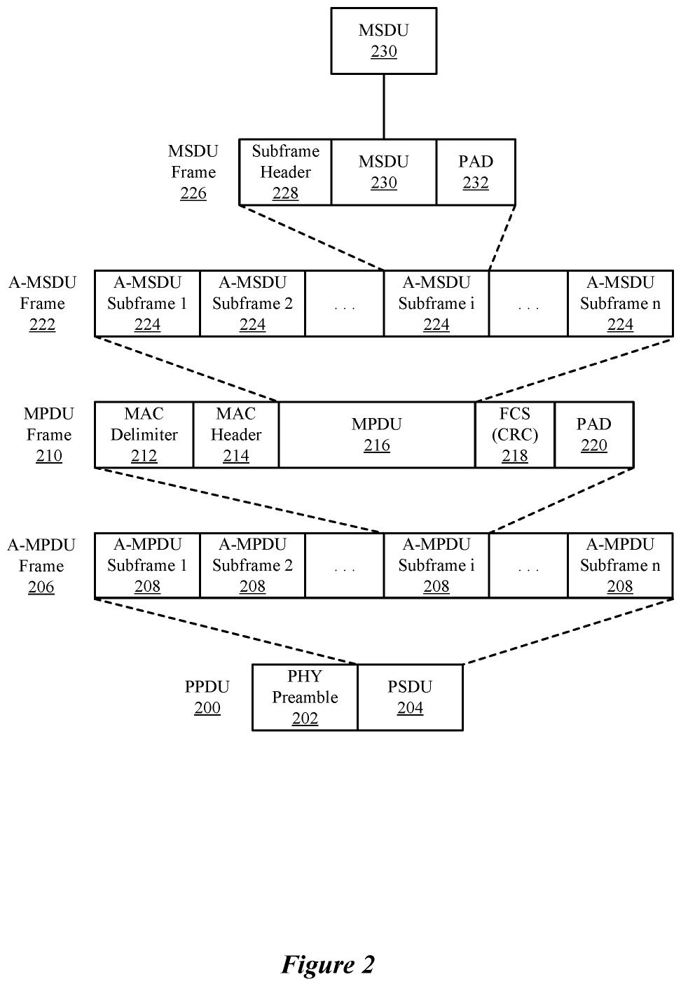

FIG. 2 shows a hierarchical format of an example PPDU usable for communications between a wireless AP and one or more wireless STAs. For example, the AP and STAs may be implementations of the AP 102 and the STAs 104 described with reference to FIG. 1. As described, each PPDU 200 includes a PHY preamble 202 and a PSDU 204. Each PSDU 204 may represent (or “carry”) one or more MAC protocol data units (MPDUs) 216. For example, each PSDU 204 may carry an aggregated MPDU (A-MPDU) 206 that includes an aggregation of multiple A-MPDU subframes 208. Each A-MPDU subframe 206 may include an MPDU frame 210 that includes a MAC delimiter 212 and a MAC header 214 prior to the accompanying MPDU 216, which includes the data portion (“payload” or “frame body”) of the MPDU frame 210. Each MPDU frame 210 also may include a frame check sequence (FCS) field 218 for error detection (such as the FCS field may include a cyclic redundancy check (CRC)) and padding bits 220. The MPDU 216 may carry one or more MAC service data units (MSDUs) 216. For example, the MPDU 216 may carry an aggregated MSDU (A-MSDU) 222 including multiple A-MSDU subframes 224. Each A-MSDU subframe 224 contains a corresponding MSDU 230 preceded by a subframe header 228 and in some implementations followed by padding bits 232.

Referring back to the MPDU frame 210, the MAC delimiter 212 may serve as a marker of the start of the associated MPDU 216 and indicate the length of the associated MPDU 216. The MAC header 214 may include multiple fields containing information that defines or indicates characteristics or attributes of data encapsulated within the frame body 216. The MAC header 214 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 214 also includes one or more fields indicating addresses for the data encapsulated within the frame body 216. For example, the MAC header 214 may include a combination of a source address, a transmitter address, a receiver address, or a destination address. The MAC header 214 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented using time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device (such as the AP 102 or the STA 104) may implement the DCF using carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables different types of traffic to be prioritized in the network.

In some other implementations, the wireless communication device (such as the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving at least some levels of throughput or satisfying at least some latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6-bit field carried by the SIG field). Each STA 104 may learn its own BSS color based on association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be in proximity to one another such that at least some of their wireless coverage areas at least partially overlap. Some implementations may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a plurality of portions of the TXOP includes a set of time resources that do not overlap with any time resources of any other portion of the plurality of portions of the TXOP. In such implementations, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and may achieve improvements in throughput fairness. Further, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some implementations in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific implementations, the sharing AP may transmit a coordinated AP TXOP indication (CTI) frame to other APs that indicates time and frequency of resources of the TXOP that can be shared. The sharing AP may select one or more candidate APs based on receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other implementations, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as discussed above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some implementations, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some, or all of the original parity bits, as well as other, different parity bits in the second HARQ transmission. The combined HARQ transmissions may be processed for decoding and error correction such that the complete signal associated with the HARQ transmissions can be obtained.

In some implementations, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

According to some aspects of the present disclosure, a first AP (such as an AP 102) may transmit, to a second AP (such as an AP 102), a first signal on a secondary primary channel indicating that the first AP has a portion of a TXOP available to share with the second AP. The first signal may indicate allocation information for the portion of the TXOP being shared. The allocation information may identify resources allocated to the shared portion of the TXOP, such as the start time of the portion of the TXOP that is available to share with the second AP, the end time of the TXOP, the frequency resources (such as subchannel or resource unit) that is available to share with the second AP, or any combination thereof. The first AP may transmit a second signal on the secondary primary channel to the second AP indicating that the portion of the TXOP is available for use by the second AP.

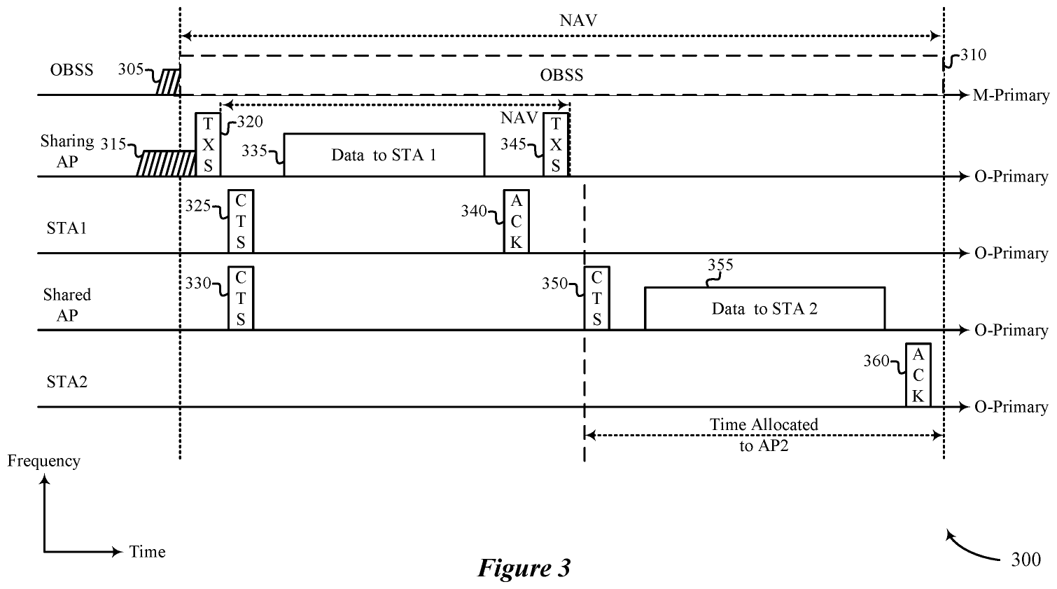

FIG. 3 shows an example of a resource diagram 300 that supports enabling coordinated multiple access on multiple primary channels. The resource diagram 300 may implement or by implemented by aspects of WLAN 100, as shown and described with reference to FIG. 1. For example, aspects of the resource diagram 300 may be implemented at or implemented by an AP or a STA, which may be implementations of the corresponding device described herein, such as an AP 102 or a STA 104 described with reference to FIG. 1.

Various aspects of the resource diagram 300 relate generally to improving the efficiency of multi primary channel access schemes. Some aspects more specifically relate to providing channel assistance information that supports multi primary channel access or eMLSR operations at a wireless AP, wireless STA, or both. That is, although some implementations of the techniques described herein may be described in terms of C-TDMA multiple primary channel access within an allocated bandwidth, it is to be understood that these techniques may be applicable in eMLSR operations at a wireless AP, a wireless STA, or both, where the secondary primary channels are in different bandwidths.

Wireless networks may generally support large bandwidths, such as bandwidths up to 320 MHz. Within a large bandwidth, one 20 MHz channel may be designated as the primary channel and wireless devices contend for access on the primary channel. For example, at 305 an OBSS device (such as an AP 102 or a STA 104 discussed with reference to FIG. 1) may attempt to capture the primary channel by monitoring an energy level of the primary channel or by detecting an 802.11 signal preamble. At 310, the OBSS device may capture the channel and may advertise a NAV to let other wireless devices know how long the OBSS device intends to use the primary channel. The duration of time for which the OBSS device can use the primary channel, known as a TXOP, may help other wireless devices determine when the first channel will become available again (such as by identifying or otherwise determining the end time of the TXOP).

Generally, access to the full bandwidth is contingent on access to the primary channel. In the situation where an OBSS device occupies the primary channel, the remainder of the allocated bandwidth remains unused, which lowers throughput and increases latency rates for the wireless communications.

Some wireless networks may support multi-primary channel access where wireless devices can use multiple channels or sub-channels, such as a main primary (M-Primary) channel or an opportunistic primary (O-Primary) channel, for channel access and to communicate with other wireless devices. As described herein, multi-primary channel access also may be referred to as non-primary channel access or secondary primary channel access. As described herein, an M-Primary channel also may be referred to as a primary channel, a primary sub-channel or a first primary channel, and an O-Primary channel may be referred to as a non-primary sub-channel, a secondary primary channel, anchor channel, auxiliary primary channel, or a second primary channel.

Some wireless devices that support multi-primary channel access may be configured to contend for access on a secondary primary channel (such as an O-Primary channel). For example, if a first AP (a sharing AP) determines that the primary channel is occupied, the first AP may read a duration indication provided by the OBSS device to identify or otherwise determine when the TXOP or the PPDU of the OBSS will end (such as the Duration field in the MAC header or the Length field in the L-SIG field of the PPDU). At 315 the first AP may retune to the secondary primary channel and contend for access to the secondary primary channel (such as an O-Primary channel) by monitoring an energy level of the primary channel or by detecting an 802.11 signal preamble. If the first AP determines that the secondary primary channel is available, at 320 the first AP may transmit or otherwise provide a first signal on the secondary primary channel indicating that the first AP has a portion of the TXOP available to share with a second AP (a shared AP).

For example, the first AP may identify or otherwise determine that it has wireless communications to perform with a first STA (such as a STA 104 discussed with reference to FIG. 1) within its coverage area. The first AP may identify or otherwise determine that the duration of the TXOP and resources associated with the secondary primary channel (such as frequency resources, time resources, or spatial resources) exceed the resources used for its communications with the first STA. Accordingly, the first AP may determine or select to share the portion of the TXOP on the secondary primary channel with the second AP. The portion of the TXOP being shared may correspond to the portion of the TXOP that remains after the first AP performs its wireless communications with the first STA and until the duration of the TXOP indicated by the OBSS device on the primary channel.

Accordingly, the first signal may carry or otherwise indicate resource allocation information for the shared TXOP on the secondary primary channel. The first signal may be provided a TXOP sharing (TXS) frame. The first signal may identify or otherwise indicate information for the resources associated with the TXOP. For example, the first AP may configure the first signal to identify the duration of the TXOP of the OBSS device, to indicate a NAV for its communications with the first STA, available frequency resources for the portion of the TXOP being shared, or other allocation information supporting the multiple primary channel access techniques.

In some implementations, the first signal also may carry or otherwise convey allocation information to be used for the wireless communications with the first STA during a first portion of the TXOP (the non-shared portion of the TXOP). The first signal may indicate the NAV for the wireless communications with the first STA, identify resources to be used, and other parameter to be used for the wireless communications with the first STA. The first signal may be sent in a non-high throughput (HT) duplicate PPDU format such that the receiving device (such as the first STA or the second AP) may decode the PPDU on any channel within the first AP's bandwidth.

At 325 the first STA may transmit or otherwise provide a response to the first AP. The response from the first STA may be provided in a clear-to-send (CTS) frame. The response may be carried or otherwise conveyed in a trigger-based PPDU to enable the first AP to determine which subset of STA(s) addressed in the first signal responded to the first AP. The response may carry or otherwise convey an indication that confirms the first STA will participate in the wireless communications with the first AP. The response from the first STA may be provided on the secondary primary channel. The response from the first STA may provide a confirmation that the first STA is tuned to the secondary primary channel.

At 330 the second AP (the shared AP) may transmit or otherwise provide a response to the first AP. The response from the second AP may be provided in a CTS frame. The response may be carried or otherwise conveyed in a trigger-based PPDU to enable the first AP to determine which subset of AP(s) addressed in the first signal responded to the first AP. The response may carry or otherwise convey an indication that the second AP is requesting to use or will otherwise use the shared the portion of the TXOP with the first AP. The response from the second AP may be provided on the secondary primary channel. The response from the second AP may provide a confirmation that the second AP is tuned to the secondary primary channel.

At 335 the first AP may transmit data to the first STA according to the allocation information indicated in the TXS frame. For example, the first AP may transmit data to the first STA on the secondary primary channel.

At 340, the first STA may transmit or otherwise provide an acknowledgement (ACK) frame to the first AP. The ACK frame may indicate information acknowledging or otherwise confirming receipt of a MPDU. The ACK frame may be a block ACK frame indicating the status of MPDUs (such as indicating a “1” for successful receipt or a “0” for failure) of each MPDU within an aggregate MPDU through a bitmap. The ACK frame may be provided via the secondary primary channel. The ACK frame may confirm that the first STA has successfully received and decoded the data.

At 345, the first AP may transmit or otherwise provide (and the second AP may receive or otherwise obtain) a second signal on the secondary primary channel that indicates that the portion of the TXOP is available for use. The second signal may be provided in a TXS frame. The second signal may carry or otherwise convey an indication that the first AP is relinquishing the secondary primary channel for use by the second AP for the remaining portion of the OBSS TXOP.

At 350, the second AP may transmit or otherwise provide (and the first AP may receive or otherwise obtain) a response on the secondary primary channel. The response may be provided in a CTS frame. The response may indicate that the second AP has wireless communications to perform with a second STA (such as a STA 104 discussed with reference to FIG. 1) located within the coverage area of the second AP. The response may carry or otherwise convey an indication of allocation information for the wireless communications with the second STA. The response may indicate frequency or other resources available for/to be used for the wireless communications with the second STA. The response may indicate the portion of the TXOP that has been shared with the second AP, such as indicating a NAV for the shared portion of the TXOP. The NAV may be associated with the wireless communications with the second STA during the shared portion of the TXOP.

At 355 the second AP may transmit data to the second STA on the secondary primary channel. The data may be transmitted to the second STA according to the allocation information provided in the CTS frame. At 360 the second STA may transmit or otherwise provide an ACK frame to the second AP. The ACK frame may be provided in the secondary primary channel and may indicate feedback for the data transmission to the second STA. The ACK frame may be a single-MPDU ACK frame or may be a block ACK frame.

In some aspects, the first AP and the second AP may exchange capability signaling. The capability signaling may indicate whether the first AP or the second AP supports multiple access techniques (such as C-TDMA or eMLSR techniques) on multi primary channels (such as at least one M-Primary and one or more O-Primary channel(s)). The first signal or the second signal may be provided based on the capability signaling.

In some implementations, the capability signaling may carry or otherwise indicate support for sharing the portion of the TXOP(s) and for receiving the shared portion of the TXOP(s), may indicate support for sharing the portion of the TXOP(s), or may indicate support for receiving the shared portion of the TXOP(s). In some implementations, the capability signaling may carry or otherwise indicate support for all secondary primary channels (such as for all O-Primary channels) or support for sharing none of the secondary primary channels or may indicate support for sharing a subset of the secondary primary channels (such as sharing specific O-Primary channels). For example, the capability signaling may carry or otherwise convey a bitmap indicating which of the secondary primary channels that are supported for sharing/being shared.

Accordingly, the first signal or the second signal may be provided based on the capability signaling. For example, the first STA may transmit the first signal (such as configure the TXS frame) on a secondary primary channel to indicate that the portion of the TXOP is available for sharing based on capability signaling from the second AP indicating support for receiving the shared portion of the TXOP on the secondary primary channel.

In some implementations, the second AP may transmit or otherwise provide (and the first AP may receive or otherwise obtain) a control message indicating that the second AP has released the portion of the TXOP to the first AP. That is, the second AP may identify or otherwise determine that it does not have communications to perform during the shared portion of the TXOP. Accordingly, the second AP may release the shared portion of the TXOP to the first AP, which may attempt to share the portion with another AP, may use the shared portion for additional communications with STA(s), or may discard the shared portion of the TXOP. The control message may be a Contention free end (CF-End) frame. The control message may be transmitted by the second AP in response to the second signal.

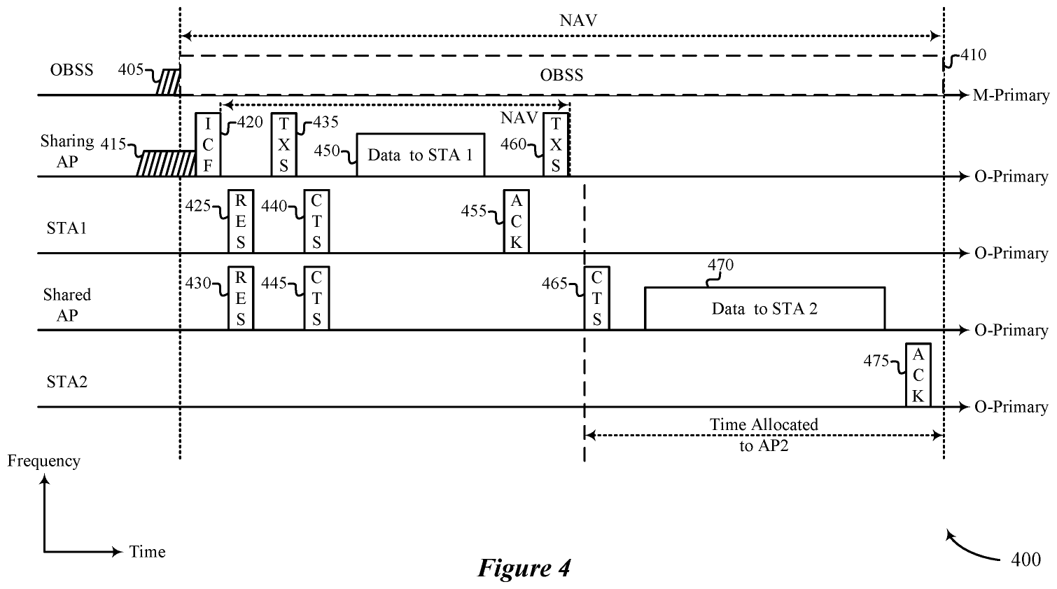

FIG. 4 shows an example of a resource diagram 400 that supports enabling coordinated multiple access on multiple primary channels. The resource diagram 400 may implement or by implemented by aspects of WLAN 100, as shown and described with reference to FIG. 1. For example, aspects of the resource diagram 400 may be implemented at or implemented by an AP or a STA, which may be implementations of the corresponding device described herein, such as an AP 102 or a STA 104 described with reference to FIG. 1.

Multi-primary channel access features may use an initial control frame (ICF) on the secondary primary channel from the TXOP holder (such as the sharing AP) to the TXOP responder (such as the shared AP). The ICF and its response generally ensures (such as confirms) that the peer device is present on the secondary primary channel and, therefore, available for subsequent frame exchanges.

In some implementations, the ICF may be provided via a control frame such as the multi-user request-to-send (MU-RTS) trigger frame or in a buffer status report poll (BSRP) trigger frame. For example, the multiple primary channel access feature may use a low capability radio, which may be referred to as an auxiliary radio, on the secondary primary channel (such as to monitor or to communicate on the O-Primary). The auxiliary radio may be used to receive the MU-RTS or BSRP trigger frame. Resource diagram 400 shows non-limiting implementations of the first AP (the sharing AP) indicating the allocation information for the shared portion of the TXOP in the ICF or in the TXS frame.

For example, at 405 an OBSS device (such as an AP 102 or a STA 104 discussed with reference to FIG. 1) may attempt to capture the primary channel by monitoring an energy level of the primary channel or by detecting an 802.11 signal preamble. At 410, the OBSS device may capture the channel and may advertise a NAV to let other wireless devices know how long the OBSS device intends to use the primary channel (such as to identify the TXOP).

At 415 the first AP may retune to the secondary primary channel and contend for access to the secondary primary channel (such as an O-Primary channel) by monitoring an energy level of the secondary primary channel or by detecting an 802.11 signal preamble. If the first AP determines that the secondary primary channel is available, at 420 the first AP may optionally transmit or otherwise provide an ICF message on the secondary primary channel. The ICF transmitted at 420 may be provided using a MU-RTS or BSRP trigger frame.

In some implementations, the ICF message may serve as a message sent to confirm that the second AP and any other STA(s) that are addressed in the IFC are tuned to the secondary primary channel. For example, at 425 the first STA may optionally respond to the ICF message with a response message confirming receipt of the ICF message. Similarly, at 430 the second AP may optionally transmit or otherwise provide a response message to the first AP confirming that it has successfully received and decoded the ICF message. Thus, in some implementations the response message(s) received from the first STA or the second AP may serve as confirmation that the responding device(s) are tuned to the secondary primary channel.

At 435, the first AP may transmit or otherwise provide a first signal that may carry or otherwise indicate resource allocation information for the shared TXOP on the secondary primary channel. The first signal may be provided a TXS frame. The first signal may identify or otherwise indicate information for the resources associated with the TXOP. For example, the first AP may configure the first signal to identify the duration of the TXOP of the OBSS device, to indicate a NAV for its communications with the first STA, the second AP, or both, available frequency resources for the portion of the TXOP being shared, or other allocation information supporting the multiple primary channel access techniques.

In some implementations, the first signal also may carry or otherwise convey allocation information to be used for the wireless communications with the first STA during a first portion of the TXOP (the non-shared portion of the TXOP). The first signal may indicate the NAV for the wireless communications with the first STA, identify resources to be used, and other parameter to be used for the wireless communications with the first STA.

At 440 the first STA may transmit or otherwise provide a response to the first AP. The response from the first STA may be provided in a CTS frame. The response may be carried in a trigger-based PPDU to enable the first AP to determine which subsets of STA(s) addressed in the first signal responded to the first AP. The response may carry or otherwise convey an indication that confirms the first STA will participate in the wireless communications with the first AP. The response from the first STA may be provided on the secondary primary channel. The response from the first STA may provide a confirmation that the first STA is tuned to the secondary primary channel.

At 445 the second AP (the shared AP) may transmit or otherwise provide a response to the first AP. The response from the second AP may be provided in a CTS frame. The response may be carried in a trigger based PPDU to enable the first AP to determine which subset of APs addressed in the first signal responded to the first AP. The response may carry or otherwise convey an indication that the second AP is requesting to use or will otherwise use the shared the portion of the TXOP with the first AP. The response from the second AP may be provided on the secondary primary channel. The response from the second AP may provide a confirmation that the second AP is tuned to the secondary primary channel.

Thus, in some implementations the first AP may optionally use the MU-RTS or the BSRP trigger frame as the ICF message to confirm that the responding device has tuned to the secondary primary channel. The first AP may transmit the TXS frame that identifies the allocation information (the TXS is the first signal, in this implementation, which also may be considered the transmission allocation message). This approach may reduce complexity of the responding device may allowing a single radio to be used to receive both the ICF message and the TXS frame.

However, in some other implementations the first AP may refrain from performing the ICF/RES exchange and, instead, use the TXS/CTS exchange to confirm that the device has tuned to the secondary primary channel. In some implementations, a device with an auxiliary radio (such as a second receive chain) may support receiving the ICF message or the TXS frame. This may reduce overhead of the wireless network.

At 450 the first AP may transmit data to the first STA according to the allocation information indicated in the TXS frame. For example, the first AP may transmit data to the first STA on the secondary primary channel.

At 455, the first STA may transmit or otherwise provide an ACK frame to the first AP. The ACK frame may indicate feedback information for the data transmission to the first STA. The ACK frame may be a single-MPDU ACK frame or may be a block ACK frame. The ACK frame may be provided via the secondary primary channel. The ACK frame may confirm that the first STA has successfully received and decoded the data.

At 460, the first AP may transmit or otherwise provide (and the second AP may receive or otherwise obtain) a second signal on the secondary primary channel that indicates that the portion of the TXOP is available for use. The second signal may be provided in a TXS frame. The second signal may carry or otherwise convey an indication that the first AP is relinquishing the secondary primary channel for use by the second AP for the remaining portion of the OBSS TXOP.

At 465, the second AP may transmit or otherwise provide (and the first AP may receive or otherwise obtain) a response on the secondary primary channel. The response may be provided in a CTS frame. The response may indicate that the second AP has wireless communications to perform with a second STA (such as a STA 104 discussed with reference to FIG. 1) located within the coverage area of the second AP. The response may carry or otherwise convey an indication of allocation information for the wireless communications with the second STA. The response may indicate frequency or other resources available for/to be used for the wireless communications with the second STA. The response may indicate the portion of the TXOP that has been shared with the second AP, such as indicating a NAV for the shared portion of the TXOP. The NAV may be associated with the wireless communications with the second STA during the shared portion of the TXOP.

At 470 the second AP may transmit data to the second STA on the secondary primary channel. The data may be transmitted to the second STA according to the allocation information provided in the TXS frame, the CTS frame, or both. At 475 the second STA may transmit or otherwise provide an ACK frame to the second AP. The ACK frame may be provided in the secondary primary channel and may indicate feedback for the data transmission to the second STA. The ACK frame may be a single-MPDU ACK frame or a block ACK frame.

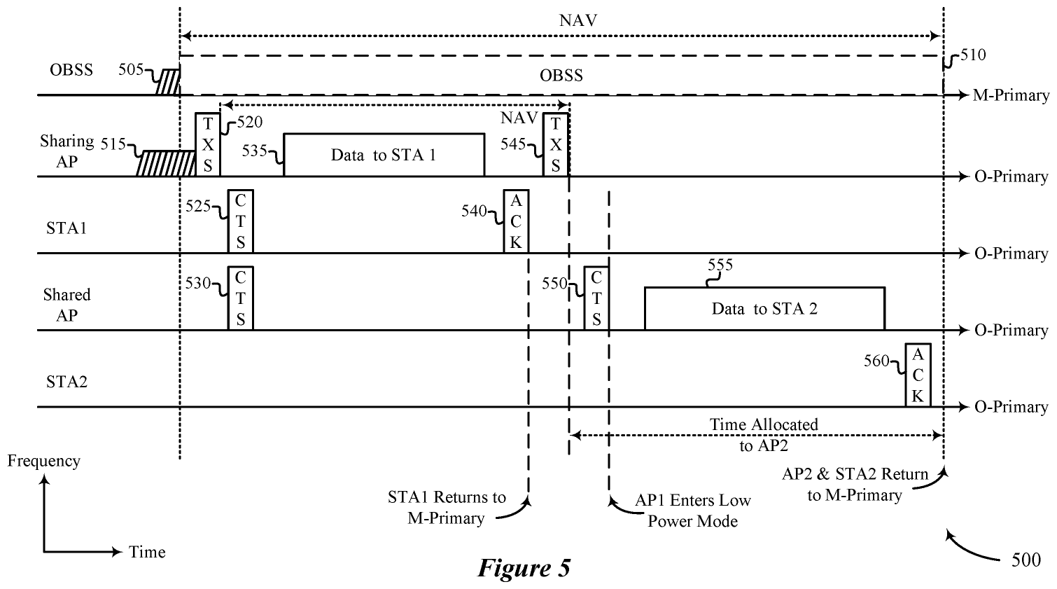

FIG. 5 shows an example of a resource diagram 500 that supports enabling coordinated multiple access on multiple primary channels. The resource diagram 500 may implement or by implemented by aspects of WLAN 100, as shown and described with reference to FIG. 1. For example, aspects of the resource diagram 500 may be implemented at or implemented by an AP or a STA, which may be implementations of the corresponding device described herein, such as an AP 102 or a STA 104 described with reference to FIG. 1.

Resource diagram 500 shows a non-limiting example of wireless device returning to the primary channel after a shared TXOP has been coordinated and performed. Multiple primary channel access techniques generally include the coordinating APs to retune their primary radio to the primary channel (the M-Primary channel) no later than the TXOP of the OBSS device on the primary channel. That is, once multiple APs have coordinated or shared using the secondary primary channel, all APs may return to the primary channel by the end of the OBSS TXOP.

For example, at 505 an OBSS device (such as an AP 102 or a STA 104 discussed with reference to FIG. 1) may attempt to capture the primary channel by monitoring an energy level of the primary channel or by detecting an 802.11 signal preamble. At 510, the OBSS device may capture the channel and may advertise a NAV to let other wireless devices know how long the OBSS device intends to use the primary channel (such as to identify the TXOP).

At 515 the first AP may retune to the secondary primary channel and contend for access to the secondary primary channel (such as an O-Primary channel) by monitoring an energy level of the primary channel or by detecting an 802.11 signal preamble. If the first AP determines that the secondary primary channel is available, at 520 the first AP may transmit or otherwise provide a first signal that may carry or otherwise indicate resource allocation information for the shared TXOP on the secondary primary channel. The first signal may be provided a TXS frame. The first signal may identify or otherwise indicate information for the resources associated with the TXOP. For example, the first AP may configure the first signal to identify the duration of the TXOP of the OBSS device, to indicate a NAV for its communications with the first STA, available frequency resources for the portion of the TXOP being shared, or other allocation information supporting the multiple primary channel access techniques.

In some implementations, the first signal also may carry or otherwise convey allocation information to be used for the wireless communications with the first STA during a first portion of the TXOP (the non-shared portion of the TXOP). The first signal may indicate the NAV for the wireless communications with the first STA, identify resources to be used, and other parameter to be used for the wireless communications with the first STA. In some implementations, the total time allocated by the first AP for the shared portion of the TXOP in combination with the time that the first AP uses for its communications with the first STA may not exceed the OBSS TXOP duration.

At 525 the first STA may transmit or otherwise provide a response to the first AP. The response from the first STA may be provided in a CTS frame. The response may carry or otherwise convey an indication that confirms the first STA will participate in the wireless communications with the first AP. The response from the first STA may be provided on the secondary primary channel. The response from the first STA may provide a confirmation that the first STA is tuned to the secondary primary channel.

At 530 the second AP (the shared AP) may transmit or otherwise provide a response to the first AP. The response from the second AP may be provided in a CTS frame. The response may carry or otherwise convey an indication that the second AP is requesting to use or will otherwise use the shared the portion of the TXOP with the first AP. The response from the second AP may be provided on the secondary primary channel. The response from the second AP may provide a confirmation that the second AP is tuned to the secondary primary channel.

At 535 the first AP may transmit data to the first STA according to the allocation information indicated in the TXS frame. For example, the first AP may transmit data to the first STA on the secondary primary channel.

At 540, the first STA may transmit or otherwise provide an ACK frame to the first AP. The ACK frame may indicate feedback information for the data transmission to the first STA. The feedback may be provided via the secondary primary channel. The feedback may confirm that the first STA has successfully received and decoded the data.

As shown in FIG. 5, based on transmitting the feedback information the first STA may return to the primary channel (the M-Primary channel). For example, the first STA may retune from the secondary primary channel to the primary channel based on transmitting the feedback. In some implementations, the first signal may carry or otherwise convey an indication that the first STA is to return to the primary channel after its communications with the first AP. For example, the NAV indication provided in the first signal may signal that, based on expiration of the NAV, the first STA is to retune to the primary channel. In some implementations, the first AP may trigger the first STA to retune to the primary channel by transmitting a frame that is addressed to a different wireless device (such as a frame that is not addressed to the first STA). In some implementations, the first AP may trigger the first STA to retune to the primary channel by setting a “More Data” bit to “0” at 535 to indicate that the wireless communications from the first AP are completed.

At 545, the first AP may transmit or otherwise provide (and the second AP may receive or otherwise obtain) a second signal on the secondary primary channel that indicates that the portion of the TXOP is available for use. The second signal may be provided in a TXS frame. The second signal may carry or otherwise convey an indication that the first AP is relinquishing the secondary primary channel for use by the second AP for the remaining portion of the OBSS TXOP.

At 550, the second AP may transmit or otherwise provide (and the first AP may receive or otherwise obtain) a response on the secondary primary channel. The response may be provided in a CTS frame. The response may indicate that the second AP has wireless communications to perform with a second STA (such as a STA 104 discussed with reference to FIG. 1) located within the coverage area of the second AP. The response may carry or otherwise convey an indication of allocation information for the wireless communications with the second STA. The response may indicate frequency or other resources available for/to be used for the wireless communications with the second STA. The response may indicate the portion of the TXOP that has been shared with the second AP, such as indicating a NAV for the shared portion of the TXOP. The NAV may be associated with the wireless communications with the second STA during the shared portion of the TXOP.

As shown in FIG. 5, in some implementations the first AP may transition to a lower power mode for the remaining duration of the TXOP. That is, in some implementations the first AP or the first STA may both transition to a low power mode to save power during the shared portion of the TXOP. In some implementations, the low power mode may be triggered by receipt of the CTS frame from the second AP.

At 555 the second AP may transmit data to the second STA on the secondary primary channel. The data may be transmitted to the second STA according to the allocation information provided in the CTS frame. At 560 the second STA may transmit or otherwise provide an ACK frame to the second AP. The ACK frame may be provided in the secondary primary channel and may indicate feedback for the data transmission to the second STA. The ACK frame may be a single-MPDU ACK frame or may be a block ACK frame.

Based on receipt of the feedback from the second STA, the second STA and the second AP may both retune from the secondary primary channel to the primary channel. As discussed, this may include the first AP, the first STA, the second AP, and the second STA retuning from the secondary primary channel to the primary channel to again begin channel access procedures on the primary channel.

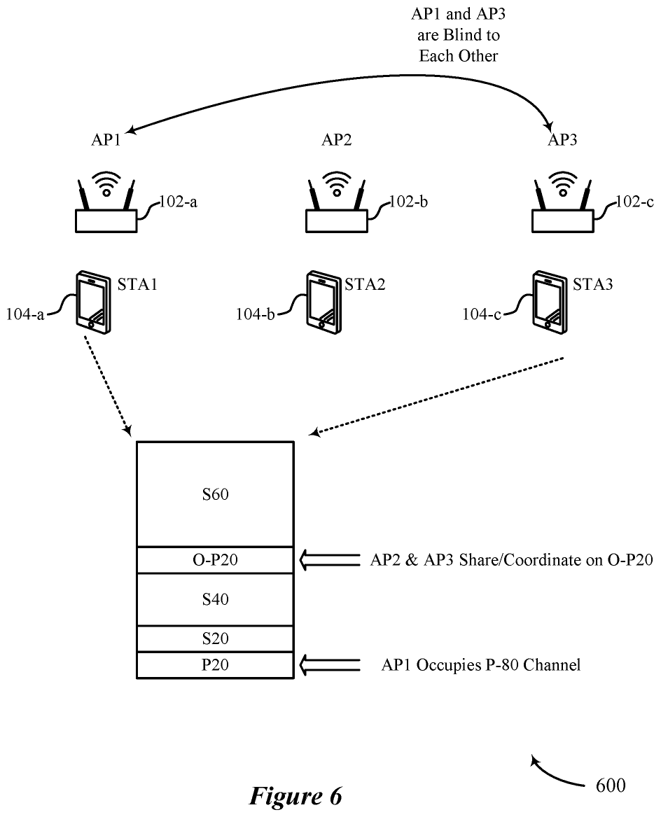

FIG. 6 shows an example of a resource diagram 600 that supports enabling coordinated multiple access on multiple primary channels. The resource diagram 600 may implement or by implemented by aspects of WLAN 100, as shown and described with reference to FIG. 1. For example, aspects of the resource diagram 600 may be implemented at or implemented by an AP 102-a, a AP 102-b, a AP 102-c, a STA 104-a, a STA 104-b, or a STA 104-c, which may be implementations of the corresponding device described herein, such as an AP 102 or a STA 104 described with reference to FIG. 1.

Resource diagram 600 illustrates a non-limiting example of a hidden AP scenario that may occur. That is, some implementations discussed herein may be based on the sharing AP and the shared AP both observing the OBSS device occupying the primary channel. For example, both the sharing AP and the shared AP may be located within a threshold range of the OBSS device (such as an OBSS STA or an OBSS AP). Accordingly, both devices may be able to receive the signal from the OBSS announcing that it has captured the primary channel for the duration of the TXOP.

However, resource diagram 600 illustrates a non-limiting example of the hidden AP scenario where the AP 102-a and the AP 102-c are unable to receive transmissions from each other. However, the AP 102-a may capture the primary channel to use for wireless communications during a TXOP. Thus, while the AP 102-a may have announced that it has captured the primary channel for the TXOP, the AP 102-c may not be aware of the announcement because the AP 102-c is located too far from the AP 102-a to receive the announcement. Moreover, in some implementations the AP 102-a may be a legacy AP that supports a more narrowband of communications (such as communications in an 80 MHz bandwidth using the 20 MHz primary channel, a 20 MHz secondary channel, and a 40 MHz secondary channel) or may not support coordinating with nearby AP(s). The AP 102-b and the AP 102-c, however, may support inter-AP coordination as well as more wideband communications using the full bandwidth (such as using the full 160 MHz bandwidth). For example, the AP 102-b and the AP 102-c may both support multiple primary channel access techniques using one or more secondary primary channel(s) (such as a 20 MHz O-Primary channel, O-P20).

Accordingly, this may create the situation where the AP 102-a has captured the primary channel and the AP 102-b is aware of this, but the AP 102-c is unaware that the AP 102-a has capture the primary channel. Accordingly, the AP 102-b may retune from the primary channel to the secondary channel to attempt to capture the remaining portion of the OBSS TXOP in the secondary primary channel. The AP 102-c, however, may attempt to capture the channel using the primary channel as it is unaware that the AP 102-a has done so. The AP 102-b may use the 80 MHz secondary channel using multiple primary channel access techniques while the AP 102-c may use the full 160 MHz bandwidth using spatial reuse techniques (such as due to the separation between the AP 102-a and the AP 102-c). This may result in different scenarios occurring regarding channel capture for the AP 102-b and the AP 102-c.

A first implementation may be that the AP 102-b captures the secondary channel access (the second 80 MHz channel) on the secondary primary channel before the AP 102-c captures the channel access (the full 160 MHz channel) on the primary channel. Resource diagram 700 below shows a non-limiting example of coordination techniques that may be used by the AP 102-b and the AP 102-c for this first implementation.

A second implementation may be that the AP 102-c captures the channel access (the full 160 MHz channel) on the primary channel before the AP 102-b captures the secondary channel access (the second 80 MHz channel) on the secondary primary channel. Resource diagram 800 below shows a non-limiting example of coordination techniques that may be used by the AP 102-b and the AP 102-c for this second implementation.

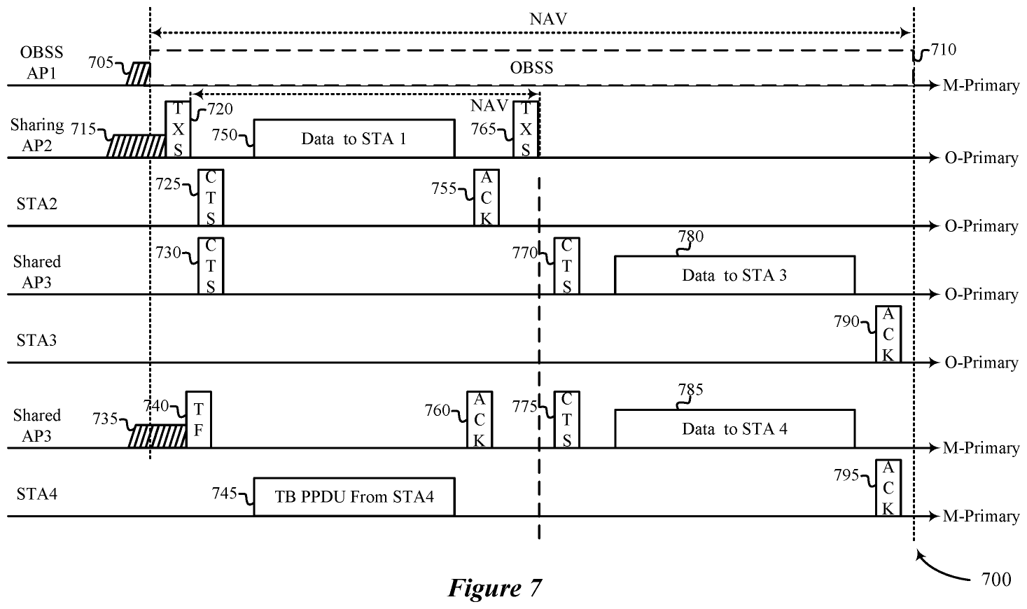

FIG. 7 shows an example of a resource diagram 700 that supports enabling coordinated multiple access on multiple primary channels. The resource diagram 700 may implement or by implemented by aspects of WLAN 100, as shown and described with reference to FIG. 1. Resource diagram 700 may implement aspects of resource diagram 600, as shown and described herein with reference to FIG. 6. For example, aspects of the resource diagram 700 may be implemented at or implemented by an AP or a STA, which may be implementations of the corresponding device described herein, such as an AP 102 or a STA 104 described with reference to FIG. 1.

Resource diagram 700 shows a non-limiting example of coordination techniques that may be applied in a first implementation where AP1 (the OBSS device, which may be an implementation of the AP 102-a described with reference to FIG. 6) captures the primary channel. The AP2 (the sharing AP, which may be an implementation of the AP 102-b described with reference to FIG. 6) captures the secondary channel access (the second 80 MHz channel) on the secondary primary channel before the AP3 (the shared AP, which may be an implementation of the AP 102-c described with reference to FIG. 6) captures the channel access (the full 160 MHz channel) on the primary channel. Resource diagram 700 shows a non-limiting implementation of coordination techniques that may be applied by AP2 and AP3 for this first implementation.

For example, at 705 an OBSS device (such as the AP 102-a described with reference to FIG. 6) may attempt to capture the primary channel by monitoring an energy level of the primary channel or by detecting an 802.11 signal preamble. At 710, the OBSS device may capture the channel and may advertise a NAV to let other wireless devices know how long the OBSS device intends to use the primary channel (such as to identify the TXOP). The second (AP2, which is the sharing AP in this example) may receive the indication of the NAV and may therefore be aware that AP1 has captured the primary channel for the TXOP. The second AP (AP3, which is the shared AP in this example), however, may be unaware that AP1 has captured the primary channel. In some implementations, the OBSS device may be a narrowband device such that a portion of the available frequency resources are being used during the TXOP.

At 715 the first AP may retune to the secondary primary channel and contend for access to the secondary primary channel (such as an O-Primary channel) by monitoring an energy level of the primary channel or by detecting an 802.11 signal preamble. If the first AP determines that the secondary primary channel is available, at 720 the first AP may transmit or otherwise provide a first signal that may carry or otherwise indicate resource allocation information for the shared TXOP on the secondary primary channel. The first signal may be provided a TXS frame.

At 725 the first STA may transmit or otherwise provide a response to the first AP. The response from the first STA may be provided in a CTS frame. At 730 the second AP (the shared AP) may transmit or otherwise provide a response to the first AP. The response from the second AP may be provided in a CTS frame.

Accordingly, the second AP may aware that AP1 has captured the primary channel based on the first signal received from the second AP. That is, even though the second AP may not have received the NAV advertised by AP1, the second AP may become aware that the primary channel was captured by AP1 based on the TXS frame. As discussed, the first signal may carry or otherwise convey an indication that the first AP has a portion of the TXOP available for sharing on the secondary primary channel. The first signal may be an implementation of a transmission allocation message in that it identifies or otherwise allocates the resources for the shared portion of the TXOP with other AP(s).

Resource diagram 700 illustrates a non-limiting example of where the second AP agrees the share the secondary subband or channel (such as the S-80 channel associated with the secondary primary channel) with the first AP. Resource diagram 700 further illustrates a non-limiting example where the second AP independently contends for the P-80 subband or channel (such as the P-20, P-40, or the P-80 channel associated with the primary channel). This technique may allow the second AP to use a bandwidth that is greater than the bandwidth shared by the first AP with the second AP (such as greater than 80 MHz, up to 160 MHz).

Accordingly, the second AP may identify or otherwise determine a secondary subband (such as the S-80 MHz subband or channel associated with the secondary primary channel) for sharing during the TXOP. For example, the second AP may identify the secondary subband based on the first signal.

For example, at 735 the second AP may attempt to capture the primary channel by monitoring an energy level of the primary channel or by detecting an 802.11 signal preamble. The second AP may retune from the secondary subband to the primary channel or may use a second radio to monitor the primary channel (the M-Primary channel). At 740, the second AP may capture the channel and may transmit a trigger frame (TF) in the primary channel. The trigger frame may trigger an uplink transmission from (or a downlink transmission to) a fourth STA (such as a STA within the coverage area of the second AP).

At 745, the fourth STA may transmit data to the second AP using the primary subband (the primary channel or subband associated with the primary channel) according to the trigger frame. The data transmitted to the second AP may include a quantity or set of PPDUs being provided in the primary channel.

At 750 the first AP may transmit data to the first STA according to the allocation information indicated in the TXS frame. For example, the first AP may transmit data to the first STA on the secondary primary channel. At 755, the first STA may transmit or otherwise provide an ACK frame to the first AP. The ACK frame may indicate feedback information for the data transmission to the first STA. The HARQ feedback may be provided via the secondary primary channel. The ACK frame may be a single-MPDU ACK frame or may be a block ACK frame.

At 760, the second AP may transmit or otherwise provide an ACK frame to the fourth STA. The ACK frame may indicate feedback information for the communications from the fourth STA. The ACK frame may be provided via the secondary channel. The ACK frame may be a single-MPDU ACK frame or may be a block ACK frame.

At 765, the first AP may transmit or otherwise provide (and the second AP may receive or otherwise obtain) a second signal on the secondary primary channel that indicates that the portion of the TXOP is available for use. The second signal may be provided in a TXS frame. The second signal may carry or otherwise convey an indication that the first AP is relinquishing the secondary primary channel for use by the second AP for the remaining portion of the OBSS TXOP.

At 770, the second AP may transmit or otherwise provide (and the first AP may receive or otherwise obtain) a response on the secondary primary channel. The response may be provided in a CTS frame. The response may indicate that the second AP has wireless communications to perform on the secondary primary channel with a STA (such as a third STA) located within the coverage area of the second AP.

At 775, the second AP may transmit or otherwise provide (and the first AP may, in some examples, receive or otherwise obtain) a response on the primary channel. The response may be provided in a CTS frame. The response may be provided in a CTS-to-self (CTS2Self) frame addressed to the second AP. The response may indicate that the second AP has wireless communications to perform on the primary channel with a STA (such as the fourth STA) located within the coverage area of the second AP.

At 780 the second AP may transmit data to the third STA on the secondary primary channel. The data may be transmitted to the third STA according to the allocation information provided in the CTS frame provided on the secondary primary channel. At 785 the second AP may transmit data to the fourth STA on the primary channel. The data may be transmitted to the fourth STA according to the allocation information provided in the CTS frame provided on the primary channel.

At 790 the third STA may transmit or otherwise provide an ACK frame to the second AP. The ACK frame may be provided in the secondary primary channel and may indicate feedback information for the data transmission to the third STA. At 795 the fourth STA may transmit or otherwise provide an ACK frame to the second AP. The ACK frame may be provided in the primary channel and may indicate feedback information for the data transmission to the fourth STA.

Aspects of resource diagram 700 may be based on whether the second AP is aware of when the non-shared portion of the TXOP of AP1 begins. As discussed, the second AP in this implementation may be blind to the OBSS device (AP1). Accordingly, the second AP may not be aware of when the TXOP begins. Moreover, in some implementations the TXS frame transmitted by the first AP on the secondary primary channel may indicate when the shared portion of the TXOP begins (such as a start time or NAV indication for the shared portion), but not when the TXOP began. In this situation, the second AP may be unaware of when the TXOP begins.

When the second AP is aware of when the TXOP begins, the second AP may perform frame exchanges with associated STA(s) on the primary channel until the end of the non-shared portion of the TXOP. The frame exchange with the STA4 may include uplink or downlink frames being exchanged (such as using triggered uplink).

When the second AP is unaware of when the TXOP begins, the second AP response may depend on a simultaneous transmit receive mode (NST) of the second AP. If the second AP is not STR across the P-80 (the primary subband associated with the primary channel) and the S-80 (secondary subband associated with the secondary primary channel), it may limit the frame exchange on the P-80 to triggered uplink communications. Alternatively, the second AP may perform short inter-frame symbols (SIFS) bursting of short PPDUs on the P-80 so that it can receive the TXS frame during receive intervals. If the second AP is STR across P-80 and S-80, it can perform either uplink or downlink frame exchanges on the P-80. Alternatively, if the second AP is STR across P-40 and S-80, it can perform either uplink or downlink frame exchanges on the P-40. If the second AP is STR across P-20 and S-80, it can perform either uplink or downlink frame exchanges on the P-20.

In some implementations, the first AP and the second AP may select the secondary primary channel (such as O-P20 channel shown in FIG. 6) based on their capability to perform STR operations between P-20 and O-P20 channel. For example, instead of selecting the O-P20 channel as the lowermost 20 MHz channel in S-80, the first AP and second AP may select O-P20 as the uppermost 20 MHz channel in S-80 so that the frequency separation between P-20 and O-P20 is the maximum possible within the 160 MHz channel bandwidth.

During the shared portion of the TXOP, the second AP may transmit simultaneously on the P-80 and the S-80 in a single MU PPDU or in a frequency domain aggregated PPDU.

Although resource diagram 700 shows a non-limiting example of the second AP sharing the S-80 with the first AP, it is to be understood that in some implementations the second AP may decide not to share the S-80 with the first AP during the shared portion of the TXOP. One example may include the second AP ignoring the allocation information provided in the TXS frame. Another example may include the second AP transmitting an indication that it will refrain from using the shared portion of the TXOP. In this situation, the first AP may continue using the TXOP on the secondary primary channel without sharing and the second AP may contend on and use the primary channel to communicate on the P-80. Aspects of resource diagram 700 may use spatial reuse techniques to support the communication on the P-80 by the second AP.

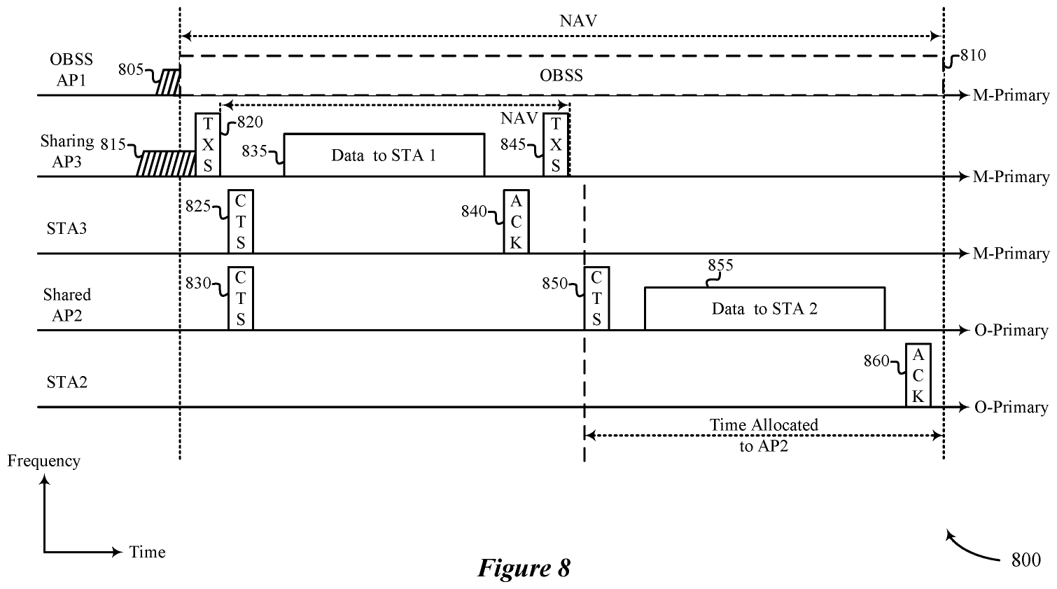

FIG. 8 shows an example of a resource diagram 800 that supports enabling coordinated multiple access on multiple primary channels. The resource diagram 800 may implement or by implemented by aspects of WLAN 100, as shown and described with reference to FIG. 1. Resource diagram 800 may implement aspects of resource diagram 600, as shown and described herein with reference to FIG. 6. For example, aspects of the resource diagram 800 may be implemented at or implemented by an AP or a STA, which may be implementations of the corresponding device described herein, such as an AP 102 or a STA 104 described with reference to FIG. 1.

Resource diagram 800 shows a non-limiting example of coordination techniques that may be applied in a second implementation where the second AP (AP3, which may be an example of the AP 102-c described with reference to FIG. 6) captures the channel access (the full 160 MHz channel) on the primary channel before the first AP (AP2, which may be an implementation of the AP 102-b described with reference to FIG. 6) captures the secondary channel access (the second 80 MHz channel) on the secondary primary channel. The second AP (AP3) may be an implementation of the sharing AP and the first AP (AP2) may be an implementation of a shared AP. Resource diagram 800 shows an implementation where, once the second AP captures the primary subband using the primary channel, it may send a transmission allocation message to the first AP indicating that the full bandwidth (the 160 MHz bandwidth) is available for sharing.

For example, at 805 an OBSS device (AP1, such as the AP 102-a described with reference to FIG. 6) may attempt to capture the primary channel by monitoring an energy level of the primary channel or by detecting an 802.11 signal preamble. At 810, the OBSS device may capture the channel and may advertise a NAV to let other wireless devices know how long the OBSS device intends to use the primary channel (such as to identify the TXOP). The second AP (AP3, which is the sharing AP in this example), however, may be unaware that AP1 has captured the primary channel due to the blind AP scenario discussed above.

Accordingly, at 815 the second AP may attempt to capture the primary subband by monitoring an energy level of the primary channel or by detecting an 802.11 signal preamble. If the second AP determines that the primary channel is available, at 820 the second AP may transmit or otherwise provide a first signal that may carry or otherwise indicate resource allocation information for the shared TXOP on the primary channel (such as the P-160 bandwidth). The first signal may be provided a TXS frame.

At 825 the first STA (STA3, which may be located within the coverage area of the second AP) may transmit or otherwise provide a response to the second AP. The response from the first STA may be provided in a CTS frame sent on the P-160 bandwidth. At 830 the first AP (the shared AP) may transmit or otherwise provide a response to the second AP. The response from the first AP may be provided in a CTS frame on the secondary primary channel on the S-80 bandwidth or any bandwidth that is less than 160 MHz and may not include the P-20 channel.

In some aspects, the TXS frame transmitted at 820 may be an implementation of a first signal that may carry or otherwise convey an indication that the second AP has a portion of the TXOP available for sharing on the primary channel. The first signal may be an example of a transmission allocation message in that it identifies or otherwise allocates the resources for the shared portion of the TXOP with other AP(s). The first signal may be sent in a non-HT duplicate PPDU format such that the receiving device (such as the first STA or the first AP) can decode the PPDU on any channel within the 160 MHz bandwidth.

Resource diagram 800 illustrates a non-limiting example of where the second AP agrees the share the secondary subband or channel (such as the S-80 channel associated with the secondary primary channel) with the second AP. For example, the second AP may identify or otherwise determine a secondary subband (such as the S-80 MHz subband or channel associated with the secondary primary channel) for sharing during the TXOP. For example, the second AP may identify the secondary subband based on the first signal.

For example, at 835 the second AP may transmit data to the third STA (STA3) according to the allocation information indicated in the TXS frame. For example, the second AP may transmit data to the first STA on the primary channel. At 840, the third STA may transmit or otherwise provide an ACK frame to the second AP. The ACK frame may indicate feedback information for the data transmission to the third STA. The ACK frame may be provided via the primary channel. The ACK frame may be a single-MPDU ACK frame or may be a block ACK frame.

At 845, the second AP may transmit or otherwise provide (and the first AP may receive or otherwise obtain) a second signal on the primary channel that indicates that the portion of the TXOP is available for use. The second signal may be provided in a TXS frame. The second signal may carry or otherwise convey an indication that the second AP is relinquishing the primary channel for use by the second AP for the remaining portion of the OBSS TXOP. The first AP may receive this signal on the first primary channel, the secondary primary channel, or both.

At 850, the first AP may transmit or otherwise provide (and the second AP may receive or otherwise obtain) a response on the secondary primary channel. The response may be provided in a CTS frame. The response may indicate that the first AP has wireless communications to perform on the secondary primary channel with a STA (such as a second STA, STA2) located within the coverage area of the first AP. In some implementations, the response may carry or otherwise convey an indication of whether the first AP intends to share the S-80 bandwidth, such as the response being sent in the secondary primary channel.

At 855, the first AP may transmit data to the second STA on the secondary primary channel. The data may be transmitted according to the allocation information provided in the CTS frame provided on the secondary primary channel.

At 860, the second STA may transmit or otherwise provide an ACK frame to the first AP. The ACK frame may be provided in the secondary primary channel and may indicate feedback feedback for the data transmission to the second STA.

Accordingly, the first AP may be aware that AP1 has captured the primary channel based on the NAV indication sent from AP1 (the OBSS device). However, the second AP may be unaware that AP1 has captured the primary channel (due to the blind AP scenario) and, instead, may capture the primary channel. The TXS frame from the second AP and the CTS responses from the first AP may indicate to the first AP that the second AP has captured the primary channel. As the first AP is aware that both AP1 and the second AP have captured the primary channel (the primary subband associated with the primary channel), different options may be employed by the first AP (the shared AP, in this scenario). In the non-limiting implementation shown in FIG. 8, the first AP (AP2) may, since AP2 determines that the primary channel is busy, determine or otherwise select to share the O-P20 (the S-80 bandwidth associated with the secondary primary channel) with the second AP. It is to be understood that the second AP may share the P-20 (the P-80 bandwidth associated with the primary channel) with other AP(s). This approach improves spectral efficiency.

However, in other scenarios the first AP may share the entire bandwidth (the 160 MHz bandwidth associated with the primary channel and the secondary primary channel) using spatial reuse techniques. For example, the first AP may use spatial reuse mechanisms to lower the power delay threshold and the transmit power. The first AP may transmit in an overlapping PPDU over AP1 on the P-80 bandwidth. Accordingly, in some implementations the first AP (the shared AP) or the second AP (the sharing AP) may reduce a transmit power level for communications in the primary subband according to the spatial reuse scheme.

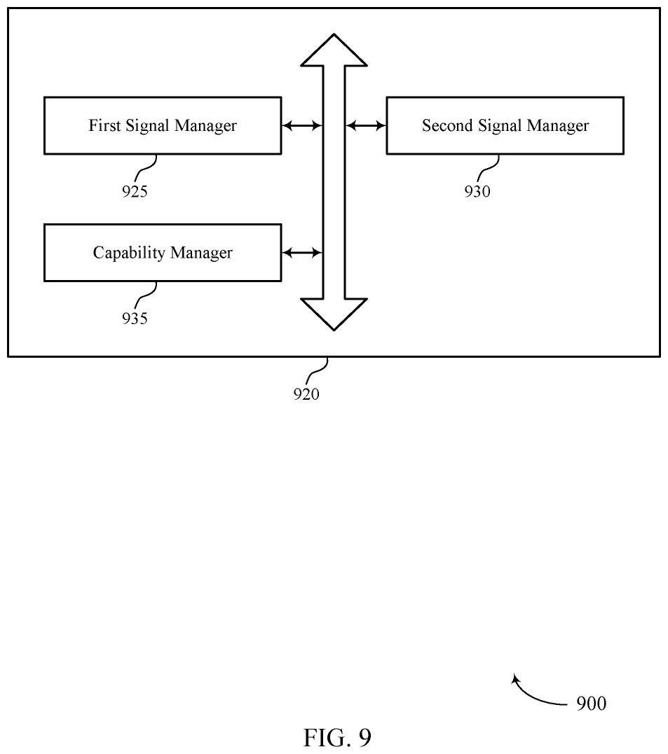

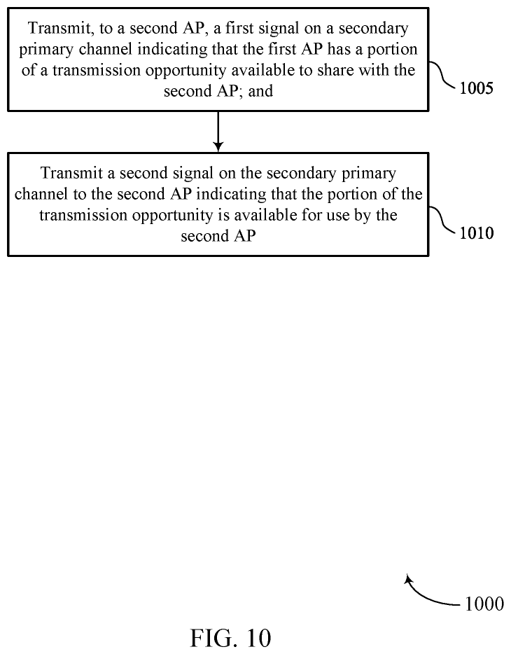

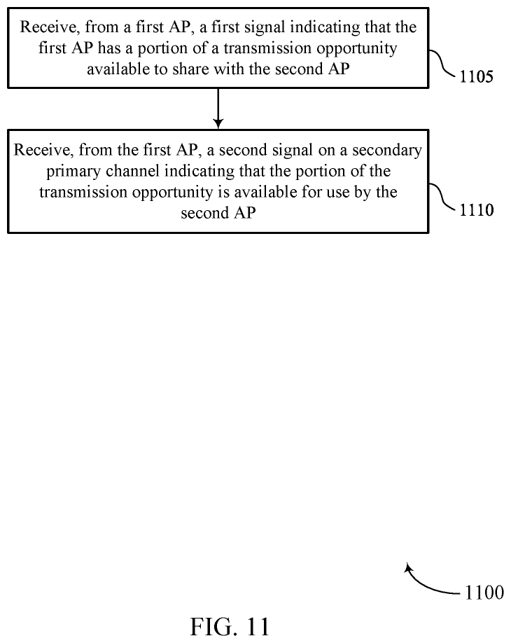

FIG. 9 shows a block diagram of an example wireless communication device 900 that supports enabling coordinated multiple access on multiple primary channels. In some implementations, the wireless communication device 900 is configured to perform the processes 1000 and 1100 described with reference to FIGS. 10 and 11, respectively. The wireless communication device 900 may include one or more chips, SoCs, chipsets, packages, components, or devices that individually or collectively constitute or include a processing system. The processing system may interface with other components of the wireless communication device 900 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an implementation, the second interface may refer to an interface between the processing system of the chip and a reception component, such that the wireless communication device 900 may receive information that is passed to the processing system. In some such implementations, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 900 can configurable or configured for use in an AP, such as the AP 102 described with reference to FIG. 1. In some other implementations, the wireless communication device 900 can be an AP that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other implementations, the wireless communication device 900 can be configurable or configured to transmit and receive signals and communications conforming to one or more 3GPP specifications including those for 5G NR or 6G. In some implementations, the wireless communication device 900 also includes or can be coupled with one or more application processors which may be further coupled with one or more other memories. In some implementations, the wireless communication device 900 further includes at least one external network interface coupled with the processing system that enables communication with a core network or backhaul network that enables the wireless communication device 900 to gain access to external networks including the Internet.

The wireless communication device 900 includes a first signal manager 925, a second signal manager 930, and a capability manager 935. Portions of one or more of the first signal manager 925, the second signal manager 930, and the capability manager 935 may be implemented at least in part in hardware or firmware. For example, one or more of the first signal manager 925, the second signal manager 930, and the capability manager 935 may be implemented at least in part by at least a processor or a modem. In some implementations, portions of one or more of the first signal manager 925, the second signal manager 930, and the capability manager 935 may be implemented at least in part by a processor and software in the form of processor-executable code stored in memory.

The wireless communication device 900 may support wireless communications in accordance with implementations as disclosed herein. The first signal manager 925 is configurable or configured to transmit, to a second AP, a first signal on a secondary primary channel indicating that the first AP has a portion of a TXOP available to share with the second AP; and. The second signal manager 930 is configurable or configured to transmit a second signal on the secondary primary channel to the second AP indicating that the portion of the TXOP is available for use by the second AP.

In some implementations, the capability manager 935 is configurable or configured to exchange capability signaling with the second AP indicating support for multiple access techniques on multiple primary channels, where the secondary primary channel includes at least one of the multiple primary channels and the transmitting the first signal, the second signal, or both, on the secondary primary channel is based on the capability signaling.

In some implementations, share the portion of the TXOP and receiving a shared portion of the TXOP, receiving a shared portion of the TXOP, or sharing the portion of the TXOP.

In some implementations, support for all secondary primary channels in the multiple primary channels, support for share a subset of secondary primary channels in the multiple primary channels, or both.

In some implementations, to support transmitting the first signal, the first signal manager 925 is configurable or configured to transmit, to the second AP, a transmission allocation message on the secondary primary channel identifying resources allocated to the portion of the TXOP. In some implementations, to support transmitting the first signal, the first signal manager 925 is configurable or configured to confirm that the second AP is tuned to the secondary primary channel according to a response message received from the second AP.

In some implementations, to support transmitting the first signal, the first signal manager 925 is configurable or configured to transmit, to the second AP, an initial control frame (ICF) message on the secondary primary channel to confirm that the second AP is tuned to the secondary primary channel. In some implementations, to support transmitting the first signal, the first signal manager 925 is configurable or configured to confirm that the second AP is tuned to the secondary primary channel according to a response received from the second AP. In some implementations, to support transmitting the first signal, the first signal manager 925 is configurable or configured to transmit, to the second AP, a transmission allocation message on the secondary primary channel identifying resources allocated to the portion of the TXOP.

In some implementations, the second signal manager 930 is configurable or configured to re-tune from the secondary primary channel to a primary channel upon (such as based on) transmission of the second signal, the second AP associated with multiple primary channels that include the primary channel and the secondary primary channel.

In some implementations, the first signal manager 925 is configurable or configured to monitor a primary channel to determine that the primary channel is unavailable for access during the TXOP having a duration associated with an overlapping TXOP on the primary channel, the first AP associated with multiple primary channels that include the primary channel and the secondary primary channel. In some implementations, the first signal manager 925 is configurable or configured to monitor the secondary primary channel to determine that the secondary primary channel is available for access, where the first signal is transmitted based on the access.

Additionally, or alternatively, the wireless communication device 900 may support wireless communications in accordance with examples as disclosed herein. In some implementations, the first signal manager 925 is configurable or configured to receive, from a first AP, a first signal indicating that the first AP has a portion of a TXOP available to share with the second AP. In some implementations, the second signal manager 930 is configurable or configured to receive, from the first AP, a second signal on a secondary primary channel indicating that the portion of the TXOP is available for use by the second AP.

In some implementations, the capability manager 935 is configurable or configured to exchange capability signaling with the first AP indicating support for multiple access techniques on multiple primary channels, where the secondary primary channel includes at least one of the multiple primary channels and the receiving the first signal, the second signal, or both, is based on the capability signaling.

In some implementations, share the portion of the TXOP and receiving a shared portion of the TXOP, receiving a shared portion of the TXOP, or sharing the portion of the TXOP.

In some implementations, support for all secondary primary channels in the multiple primary channels, support for share a subset of secondary primary channels in the multiple primary channels, or both.

In some implementations, to support receiving the first signal, the first signal manager 925 is configurable or configured to receive, from the first AP, a transmission allocation message on the secondary primary channel identifying resources allocated to the portion of the TXOP. In some implementations, to support receiving the first signal, the first signal manager 925 is configurable or configured to transmit a response to the first AP according to the transmission allocation message, where the response confirms that the second AP is tuned to the secondary primary channel.

In some implementations, to support receiving the first signal, the first signal manager 925 is configurable or configured to receive, from the first AP, an initial control frame (ICF) message on the secondary primary channel. In some implementations, to support receiving the first signal, the first signal manager 925 is configurable or configured to transmit a response to the first AP according to the ICF message, where the response confirms that the second AP is tuned to the secondary primary channel. In some implementations, to support receiving the first signal, the first signal manager 925 is configurable or configured to receive, from the first AP, a transmission allocation message on the secondary primary channel identifying resources allocated to the portion of the TXOP.

In some implementations, the second signal manager 930 is configurable or configured to re-tune from the secondary primary channel to a primary channel upon expiration of communicating with one or more wireless stations during the portion of the TXOP, the second AP associated with multiple primary channels that include the primary channel and the secondary primary channel.

In some implementations, the first signal manager 925 is configurable or configured to identifying, based at least in part on the first signal, a secondary subband that is associated with the secondary primary channel available for sharing during the portion of the TXOP, where communicating with one or more wireless stations during the portion of the TXOP is performed in the secondary subband.

In some implementations, the first signal manager 925 is configurable or configured to communicating, based at least in part on a start time of the TXOP, with one or more wireless stations during a second portion of the TXOP and in a primary subband, where the primary subband is a different subband than the secondary subband and the second portion of the TXOP occurs earlier in a time domain than the portion of the TXOP.

In some implementations, the first signal manager 925 is configurable or configured to monitor a primary channel in a primary subband and the secondary primary channel in the secondary subband. In some implementations, the first signal manager 925 is configurable or configured to communicating, based at least in part on a result of the monitoring, with one or more wireless stations during a second portion of the TXOP and in the primary subband, where the first subband is a different subband than the second subband and the second portion of the TXOP occurs earlier in a time domain than the portion of the TXOP.

In some implementations, the first signal manager 925 is configurable or configured to transmit an indication that the second AP is refraining from communicating with one or more wireless stations during the portion of the TXOP.

In some implementations, the first signal manager 925 is configurable or configured to monitor a primary channel to determine that the primary channel is unavailable for access, the second AP associated with multiple primary channels that include the primary channel and the secondary primary channel. In some implementations, the first signal manager 925 is configurable or configured to identifying, based at least in part on the first signal and a result of the monitoring, a secondary subband associated with the secondary primary channel available for sharing during the portion of the TXOP, where communicating with one or more wireless stations during the portion of the TXOP is performed in the secondary subband.

In some implementations, the first signal manager 925 is configurable or configured to monitor a primary channel to determine that the primary channel is unavailable for access, the second AP associated with multiple primary channels that include the primary channel and the secondary primary channel. In some implementations, the first signal manager 925 is configurable or configured to identifying, based at least in part on the first signal and a result of the monitoring, a primary subband and a secondary subband available for sharing during the portion of the TXOP, where communicating with one or more wireless stations during the portion of the TXOP is performed in the primary subband and the secondary subband.

In some implementations, the first signal manager 925 is configurable or configured to reduce a transmit power level for the communicating with the one or more wireless stations in the primary subband according to a spatial reuse scheme, the spatial reuse scheme based on the primary channel being unavailable for access.

In some implementations, the second signal manager 930 is configurable or configured to transmit a control message to the first AP releasing the portion of the TXOP to the first AP.

FIG. 10 shows a flowchart illustrating an example process 1000 performable by or at a first AP that supports enabling coordinated multiple access on multiple primary channels. The operations of the process 1000 may be implemented by a first AP or its components as described herein. For example, the process 1000 may be performed by a wireless communication device, such as the wireless communication device 900 described with reference to FIG. 9, operating as or within a wireless AP. In some implementations, the process 1000 may be performed by a wireless AP, such as one of the APs 102 described with reference to FIG. 1.

In some implementations, in block 1005, the first AP may transmit, to a second AP, a first signal on a secondary primary channel indicating that the first AP has a portion of a TXOP available to share with the second AP; and. The operations of block 1005 may be performed in accordance with examples as disclosed herein. In some implementations, aspects of the operations of block 1005 may be performed by a first signal manager 925 as described with reference to FIG. 9.

In some implementations, in block 1010, the first AP may transmit a second signal on the secondary primary channel to the second AP indicating that the portion of the TXOP is available for use by the second AP. The operations of block 1010 may be performed in accordance with examples as disclosed herein. In some implementations, aspects of the operations of block 1010 may be performed by a second signal manager 930 as described with reference to FIG. 9.

FIG. 11 shows a flowchart illustrating an example process 1100 performable by or at a second AP that supports enabling coordinated multiple access on multiple primary channels. The operations of the process 1100 may be implemented by a second AP or its components as described herein. For example, the process 1100 may be performed by a wireless communication device, such as the wireless communication device 900 described with reference to FIG. 9, operating as or within a wireless AP. In some implementations, the process 1100 may be performed by a wireless AP, such as one of the APs 102 described with reference to FIG. 1.

In some implementations, in block 1105, the second AP may receive, from a first AP, a first signal indicating that the first AP has a portion of a TXOP available to share with the second AP. The operations of block 1105 may be performed in accordance with examples as disclosed herein. In some implementations, aspects of the operations of block 1105 may be performed by a first signal manager 925 as described with reference to FIG. 9.

In some implementations, in block 1110, the second AP may receive, from the first AP, a second signal on a secondary primary channel indicating that the portion of the TXOP is available for use by the second AP. The operations of block 1110 may be performed in accordance with examples as disclosed herein. In some implementations, aspects of the operations of block 1110 may be performed by a second signal manager 930 as described with reference to FIG. 9.

Implementation examples are described in the following numbered clauses:
Aspect 1: A method for wireless communications at a first AP, comprising: transmitting, to a second AP, a first signal on a secondary primary channel indicating that the first AP has a portion of a TXOP available to share with the second AP; and transmitting a second signal on the secondary primary channel to the second AP indicating that the portion of the TXOP is available for use by the second AP.
Aspect 2: The method of aspect 1, further comprising: exchanging capability signaling with the second AP indicating support for multiple access techniques on multiple primary channels, wherein the secondary primary channel comprises at least one of the multiple primary channels and the transmitting the first signal, the second signal, or both, on the secondary primary channel is based at least in part on the capability signaling.
Aspect 3: The method of aspect 2, wherein the capability signaling indicates support for at least one of sharing the portion of the TXOP and receiving a shared portion of the TXOP, receiving a shared portion of the TXOP, or sharing the portion of the TXOP.
Aspect 4: The method of any of aspects 2 through 3, wherein the capability signaling indicates at least one of support for all secondary primary channels in the multiple primary channels, support for sharing a subset of secondary primary channels in the multiple primary channels, or both.
Aspect 5: The method of any of aspects 1 through 4, wherein transmitting the first signal comprises: transmitting, to the second AP, a transmission allocation message on the secondary primary channel identifying resources allocated to the portion of the TXOP; and confirming that the second AP is tuned to the secondary primary channel according to a response message received from the second AP.
Aspect 6: The method of any of aspects 1 through 5, wherein transmitting the first signal comprises: transmitting, to the second AP, an ICF message on the secondary primary channel to confirm that the second AP is tuned to the secondary primary channel; confirming that the second AP is tuned to the secondary primary channel according to a response received from the second AP; and transmitting, to the second AP, a transmission allocation message on the secondary primary channel identifying resources allocated to the portion of the TXOP.
Aspect 7: The method of any of aspects 1 through 6, further comprising: re-tuning from the secondary primary channel to a primary channel upon transmission of the second signal, the second AP associated with multiple primary channels that comprise the primary channel and the secondary primary channel.
Aspect 8: The method of any of aspects 1 through 7, further comprising: monitoring a primary channel to determine that the primary channel is unavailable for access during the TXOP having a duration associated with an overlapping TXOP on the primary channel, the first AP associated with multiple primary channels that comprise the primary channel and the secondary primary channel; and monitoring the secondary primary channel to determine that the secondary primary channel is available for access, wherein the first signal is transmitted based at least in part on the access.
Aspect 9: A method for wireless communications at a second AP, comprising: receiving, from a first AP, a first signal indicating that the first AP has a portion of a TXOP available to share with the second AP; and receiving, from the first AP, a second signal on a secondary primary channel indicating that the portion of the TXOP is available for use by the second AP.
Aspect 10: The method of aspect 9, further comprising: exchanging capability signaling with the first AP indicating support for multiple access techniques on multiple primary channels, wherein the secondary primary channel comprises at least one of the multiple primary channels and the receiving the first signal, the second signal, or both, is based at least in part on the capability signaling.
Aspect 11: The method of aspect 10, wherein the capability signaling indicates support for at least one of sharing the portion of the TXOP and receiving a shared portion of the TXOP, receiving a shared portion of the TXOP, or sharing the portion of the TXOP.
Aspect 12: The method of any of aspects 10 through 11, wherein the capability signaling indicates support for at least one of support for all secondary primary channels in the multiple primary channels, support for sharing a subset of secondary primary channels in the multiple primary channels, or both.
Aspect 13: The method of any of aspects 9 through 12, wherein receiving the first signal comprises: receiving, from the first AP, a transmission allocation message on the secondary primary channel identifying resources allocated to the portion of the TXOP; and transmitting a response to the first AP according to the transmission allocation message, wherein the response confirms that the second AP is tuned to the secondary primary channel.
Aspect 14: The method of any of aspects 9 through 13, wherein receiving the first signal comprises: receiving, from the first AP, an ICF message on the secondary primary channel; transmitting a response to the first AP according to the ICF message, wherein the response confirms that the second AP is tuned to the secondary primary channel; and receiving, from the first AP, a transmission allocation message on the secondary primary channel identifying resources allocated to the portion of the TXOP.
Aspect 15: The method of any of aspects 9 through 14, further comprising: re-tuning from the secondary primary channel to a primary channel upon expiration of communicating with one or more wireless stations during the portion of the TXOP, the second AP associated with multiple primary channels that comprise the primary channel and the secondary primary channel.
Aspect 16: The method of any of aspects 9 through 15, further comprising: identifying, based at least in part on the first signal, a secondary subband that is associated with the secondary primary channel available for sharing during the portion of the TXOP, wherein communicating with one or more wireless stations during the portion of the TXOP is performed in the secondary subband.
Aspect 17: The method of aspect 16, further comprising: communicating, based at least in part on a start time of the TXOP, with one or more wireless stations during a second portion of the TXOP and in a primary subband, wherein the primary subband is a different subband than the secondary subband and the second portion of the TXOP occurs earlier in a time domain than the portion of the TXOP.
Aspect 18: The method of any of aspects 16 through 17, further comprising: monitoring a primary channel in a primary subband and the secondary primary channel in the secondary subband; and communicating, based at least in part on a result of the monitoring, with one or more wireless stations during a second portion of the TXOP and in the primary subband, wherein the first subband is a different subband than the second subband and the second portion of the TXOP occurs earlier in a time domain than the portion of the TXOP.
Aspect 19: The method of any of aspects 16 through 18, further comprising: transmitting an indication that the second AP is refraining from communicating with one or more wireless stations during the portion of the TXOP.
Aspect 20: The method of any of aspects 9 through 19, further comprising: monitoring a primary channel to determine that the primary channel is unavailable for access, the second AP associated with multiple primary channels that comprise the primary channel and the secondary primary channel; and identifying, based at least in part on the first signal and a result of the monitoring, a secondary subband associated with the secondary primary channel available for sharing during the portion of the TXOP, wherein communicating with one or more wireless stations during the portion of the TXOP is performed in the secondary subband.
Aspect 21: The method of any of aspects 9 through 20, further comprising: monitoring a primary channel to determine that the primary channel is unavailable for access, the second AP associated with multiple primary channels that comprise the primary channel and the secondary primary channel; and identifying, based at least in part on the first signal and a result of the monitoring, a primary subband and a secondary subband available for sharing during the portion of the TXOP, wherein communicating with one or more wireless stations during the portion of the TXOP is performed in the primary subband and the secondary subband.
Aspect 22: The method of aspect 21, further comprising: reducing a transmit power level for the communicating with the one or more wireless stations in the primary subband according to a spatial reuse scheme, the spatial reuse scheme based at least in part on the primary channel being unavailable for access.
Aspect 23: The method of any of aspects 9 through 22, further comprising: transmitting a control message to the first AP releasing the portion of the TXOP to the first AP.
Aspect 24: A first AP for wireless communications, comprising one or more memories storing processor-executable code, and one or more processors coupled with the one or more memories and individually or collectively operable to execute the code to cause the first AP to perform a method of any of aspects 1 through 8.
Aspect 25: A first AP for wireless communications, comprising at least one means for performing a method of any of aspects 1 through 8.
Aspect 26: A non-transitory computer-readable medium storing code for wireless communications, the code comprising instructions executable by a processor to perform a method of any of aspects 1 through 8.
Aspect 27: A second AP for wireless communications, comprising one or more memories storing processor-executable code, and one or more processors coupled with the one or more memories and individually or collectively operable to execute the code to cause the second AP to perform a method of any of aspects 9 through 23.
Aspect 28: A second AP for wireless communications, comprising at least one means for performing a method of any of aspects 9 through 23.
Aspect 29: A non-transitory computer-readable medium storing code for wireless communications, the code comprising instructions executable by a processor to perform a method of any of aspects 9 through 23.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a−b, a−c, b−c, and a−b−c. As used herein, “or” is intended to be interpreted in the inclusive sense, unless otherwise explicitly indicated. For example, “a or b” may include a only, b only, or a combination of a and b. Further as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes discussed above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be discussed above as acting in particular combinations, and even initially claimed as such, one or more features from a claimed combination can in some implementation be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples discussed above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
transmit, to a second AP, a first signal on a secondary primary channel indicating that the first AP has a portion of a transmission opportunity available to share with the second AP; and
transmit a second signal on the secondary primary channel to the second AP indicating that the portion of the transmission opportunity is available for use by the second AP.

2. The first AP of claim 1, wherein the processing system is further configured to cause the first AP to:
exchange capability signaling with the second AP indicating support for multiple access techniques on multiple primary channels, wherein the secondary primary channel comprises at least one of the multiple primary channels and the transmitting the first signal, the second signal, or both, on the secondary primary channel is based at least in part on the capability signaling.

3. The first AP of claim 2, wherein the capability signaling indicates support for at least one of sharing the portion of the transmission opportunity and receiving a shared portion of the transmission opportunity, receiving a shared portion of the transmission opportunity, or sharing the portion of the transmission opportunity.

4. The first AP of claim 2, wherein the capability signaling indicates at least one of support for all secondary primary channels in the multiple primary channels, support for sharing a subset of secondary primary channels in the multiple primary channels, or both.

5. The first AP of claim 1, wherein, to transmit the first signal, the processing system is configured to cause the first AP to:
transmit, to the second AP, a transmission allocation message on the secondary primary channel identifying resources allocated to the portion of the transmission opportunity; and
confirm that the second AP is tuned to the secondary primary channel according to a response message received from the second AP.

6. The first AP of claim 1, wherein, to transmit the first signal, the processing system is configured to cause the first AP to:
transmit, to the second AP, an initial control frame (ICF) message on the secondary primary channel to confirm that the second AP is tuned to the secondary primary channel;
confirm that the second AP is tuned to the secondary primary channel according to a response received from the second AP; and
transmit, to the second AP, a transmission allocation message on the secondary primary channel identifying resources allocated to the portion of the transmission opportunity.

7. The first AP of claim 1, wherein the processing system is further configured to cause the first AP to:
re-tune from the secondary primary channel to a primary channel upon transmission of the second signal, the second AP associated with multiple primary channels that comprise the primary channel and the secondary primary channel.

8. The first AP of claim 1, wherein the processing system is further configured to cause the first AP to:
monitor a primary channel to determine that the primary channel is unavailable for access during the transmission opportunity having a duration associated with an overlapping transmission opportunity on the primary channel, the first AP associated with multiple primary channels that comprise the primary channel and the secondary primary channel; and
monitor the secondary primary channel to determine that the secondary primary channel is available for access, wherein the first signal is transmitted based at least in part on the access.

9. A second access point (AP), comprising:
a processing system that includes processor circuitry and memory circuitry that stores code, the processing system configured to cause the second AP to:
receive, from a first AP, a first signal indicating that the first AP has a portion of a transmission opportunity available to share with the second AP; and
receive, from the first AP, a second signal on a secondary primary channel indicating that the portion of the transmission opportunity is available for use by the second AP.

10. The second AP of claim 9, wherein the processing system is further configured to cause the second AP to:
exchange capability signaling with the first AP indicating support for multiple access techniques on multiple primary channels, wherein the secondary primary channel comprises at least one of the multiple primary channels and the receiving the first signal, the second signal, or both, is based at least in part on the capability signaling.

11. The second AP of claim 10, wherein the capability signaling indicates support for at least one of sharing the portion of the transmission opportunity and receiving a shared portion of the transmission opportunity, receiving a shared portion of the transmission opportunity, or sharing the portion of the transmission opportunity.

12. The second AP of claim 10, wherein the capability signaling indicates at least one of support for all secondary primary channels in the multiple primary channels, support for sharing a subset of secondary primary channels in the multiple primary channels, or both.

13. The second AP of claim 9, wherein, to receive the first signal, the processing system is configured to cause the second AP to:
receive, from the first AP, a transmission allocation message on the secondary primary channel identifying resources allocated to the portion of the transmission opportunity; and
transmit a response to the first AP according to the transmission allocation message, wherein the response confirms that the second AP is tuned to the secondary primary channel.

14. The second AP of claim 9, wherein, to receive the first signal, the processing system is configured to cause the second AP to:
receive, from the first AP, an initial control frame (ICF) message on the secondary primary channel;
transmit a response to the first AP according to the ICF message, wherein the response confirms that the second AP is tuned to the secondary primary channel; and
receive, from the first AP, a transmission allocation message on the secondary primary channel identifying resources allocated to the portion of the transmission opportunity.

15. The second AP of claim 9, wherein the processing system is further configured to cause the second AP to:
re-tune from the secondary primary channel to a primary channel upon expiration of communicating with one or more wireless stations during the portion of the transmission opportunity, the second AP associated with multiple primary channels that comprise the primary channel and the secondary primary channel.

16. The second AP of claim 9, wherein the processing system is further configured to cause the second AP to:
identifying, based at least in part on the first signal, a secondary subband that is associated with the secondary primary channel available for sharing during the portion of the transmission opportunity, wherein communicating with one or more wireless stations during the portion of the transmission opportunity is performed in the secondary subband.

17. The second AP of claim 16, wherein the processing system is further configured to cause the second AP to:
communicating, based at least in part on a start time of the transmission opportunity, with one or more wireless stations during a second portion of the transmission opportunity and in a primary subband, wherein the primary subband is a different subband than the secondary subband and the second portion of the transmission opportunity occurs earlier in a time domain than the portion of the transmission opportunity.

18. The second AP of claim 16, wherein the processing system is further configured to cause the second AP to:
monitor a primary channel in a primary subband and the secondary primary channel in the secondary subband; and
communicating, based at least in part on a result of the monitoring, with one or more wireless stations during a second portion of the transmission opportunity and in the primary subband, wherein the first subband is a different subband than the second subband and the second portion of the transmission opportunity occurs earlier in a time domain than the portion of the transmission opportunity.

19. The second AP of claim 16, wherein the processing system is further configured to cause the second AP to:
transmit an indication that the second AP is refraining from communicating with one or more wireless stations during the portion of the transmission opportunity.

20. The second AP of claim 9, wherein the processing system is further configured to cause the second AP to:
monitor a primary channel to determine that the primary channel is unavailable for access, the second AP associated with multiple primary channels that comprise the primary channel and the secondary primary channel; and
identifying, based at least in part on the first signal and a result of the monitoring, a secondary subband associated with the secondary primary channel available for sharing during the portion of the transmission opportunity, wherein communicating with one or more wireless stations during the portion of the transmission opportunity is performed in the secondary subband.

21. The second AP of claim 9, wherein the processing system is further configured to cause the second AP to:
monitor a primary channel to determine that the primary channel is unavailable for access, the second AP associated with multiple primary channels that comprise the primary channel and the secondary primary channel; and
identifying, based at least in part on the first signal and a result of the monitoring, a primary subband and a secondary subband available for sharing during the portion of the transmission opportunity, wherein communicating with one or more wireless stations during the portion of the transmission opportunity is performed in the primary subband and the secondary subband.

22. The second AP of claim 21, wherein the processing system is further configured to cause the second AP to:
reduce a transmit power level for the communicating with the one or more wireless stations in the primary subband according to a spatial reuse scheme, the spatial reuse scheme based at least in part on the primary channel being unavailable for access.

23. The second AP of claim 9, wherein the processing system is further configured to cause the second AP to:
transmit a control message to the first AP releasing the portion of the transmission opportunity to the first AP.

24. A method for wireless communications at a first access point (AP), comprising:
transmitting, to a second AP, a first signal on a secondary primary channel indicating that the first AP has a portion of a transmission opportunity available to share with the second AP; and
transmitting a second signal on the secondary primary channel to the second AP indicating that the portion of the transmission opportunity is available for use by the second AP.

25. The method of claim 24, further comprising:
exchanging capability signaling with the second AP indicating support for multiple access techniques on multiple primary channels, wherein the secondary primary channel comprises at least one of the multiple primary channels and the transmitting the first signal, the second signal, or both, on the secondary primary channel is based at least in part on the capability signaling.

26. The method of claim 25, wherein the capability signaling indicates support for at least one of sharing the portion of the transmission opportunity and receiving a shared portion of the transmission opportunity, receiving a shared portion of the transmission opportunity, or sharing the portion of the transmission opportunity.

27. The method of claim 25, wherein the capability signaling indicates at least one of support for all secondary primary channels in the multiple primary channels, support for sharing a subset of secondary primary channels in the multiple primary channels, or both.

28. The method of claim 24, wherein transmitting the first signal comprises:
transmitting, to the second AP, a transmission allocation message on the secondary primary channel identifying resources allocated to the portion of the transmission opportunity; and
confirming that the second AP is tuned to the secondary primary channel according to a response message received from the second AP.

29. The method of claim 24, wherein transmitting the first signal comprises:
transmitting, to the second AP, an initial control frame (ICF) message on the secondary primary channel to confirm that the second AP is tuned to the secondary primary channel;
confirming that the second AP is tuned to the secondary primary channel according to a response received from the second AP; and
transmitting, to the second AP, a transmission allocation message on the secondary primary channel identifying resources allocated to the portion of the transmission opportunity.

30. A method for wireless communications at a second access point (AP), comprising:
receiving, from a first AP, a first signal indicating that the first AP has a portion of a transmission opportunity available to share with the second AP; and
receiving, from the first AP, a second signal on a secondary primary channel indicating that the portion of the transmission opportunity is available for use by the second AP.
